(19) United States
(12) Patent Application Publication
(10) Pub. No.: US 2020/0243808 A1
(43) Pub. Date: Jul. 30, 2020

(54) BAND BATTERIES FOR SMART WEARABLE DEVICES

(71) Applicant: HONDA MOTOR CO., LTD., Tokyo (JP)

(72) Inventors: Avetik R. HARUTYUNYAN, Santa Clara, CA (US); Oleg A. KUZNETSOV, San Jose, CA (US)

(21) Appl. No.: 16/777,629

(22) Filed: Jan. 30, 2020

Related U.S. Application Data
(63) Continuation-in-part of application No. 16/560,747, filed on Sep. 4, 2019.
(60) Provisional application No. 62/895,831, filed on Sep. 4, 2019.
(60) Provisional application No. 62/798,938, filed on Jan. 30, 2019.
(60) Provisional application No. 62/798,938, filed on Jan. 30, 2019.

(51) Int. Cl. H01M 2/02; H01M 10/0525; H01M 10/058; H01M 10/0562

(52) U.S. Cl. CPC H01M 2/0275; H01M 10/0525; H01M 2300/0068; H01M 10/0562; H01M 2220/30; H01M 10/058

(57) ABSTRACT

Flexible batteries that can take the shape of a wristband, head band, ankle band, chest band, armband, sleeves, or clothing and can be used for powering corresponding smart devices.

### CROSS REFERENCE TO RELATED APPLICATIONS

This application claims priority to U.S. Provisional Application No. 62/895,831, filed Sep. 4, 2019 and U.S. Provisional Application No. 62/798,938, filed Jan. 30, 2019. This application is a continuation-in-part of U.S. patent application Ser. No. 16/560,747, filed Sep. 4, 2019, which claims priority to U.S. Provisional Application No. 62/798,938, the disclosures of which are all hereby incorporated by reference herein in their entirety.

### BACKGROUND

Advances in flexible electronics have increased the development of smart wearable devices for healthcare, the internet of things, and more. Particularly, exploitation of low-dimensional materials shows promise for development of light, transparent, and flexible wearable intelligent systems that enhance human-machine relationships. However, these intelligent systems, consisting of sensing, processing, and acting components, impose very demanding energy requirements, primarily dictated by power consumption of embedded devices such as sensors, actuators, chips, and antennas. Therefore, further progress of wearables directly depends on the rate of advancing the wearable power sources that still cannot keep pace with the rate of progress in electronics.

### SUMMARY

According to some aspects, the present disclosure is directed to wearable and flexible batteries that can take the shape of a wristband, head band, ankle band, chest band, armband, sleeves, or clothing and can be used for powering corresponding smart devices. In some embodiments, the wearable and flexible battery can be a platform for powering various smart devices. As is disclosed herein, the flexible and wearable aspects can independently arise from the various components of the battery, for example, flexible self-standing electrodes and flexible material packaging. The present disclosure is also directed to methods of making various wearable and flexible batteries, methods of use, and various devices comprised within or deriving power from the wearable and flexible batteries.

### BRIEF DESCRIPTION OF THE DRAWINGS

FIG. 1 shows a non-limiting example of a wearable and flexible battery in the form of a battery band as a smart watch band providing power to a watch.

FIG. 2 shows a wearable and flexible battery in the form of a watch band with a buckle attached at one end and flexible conductive battery tabs protruding from the opposite end, according to some embodiments of the present disclosure.

FIG. 3 shows a non-limiting example of a wearable and flexible battery in the form of a battery band as a smart watch band providing power to a watch and an embedded heart rate sensor further operative to transmit heart rate data to a cellphone via Bluetooth.

FIG. 4 shows a plot of capacity retention time (mAh/g) and cycle number at different discharge rates for an embodiment of a band battery, according to some aspects of the present disclosure.

FIG. 5 is an expanded view of a flexible battery pouch cell showing a non-limiting example of the flexible self-standing electrodes contained therein and protruding battery tabs from the electrodes illustrated according to some embodiments of the present disclosure.

FIG. 6 is a flow diagram illustrating steps of a method for making a flexible self-standing electrode, wherein electrolyte is deposited into or on a mixture of nanotubes and electrode active material, according to some embodiments of the present disclosure.

FIG. 7 is a flow diagram illustrating steps of a method for making a flexible self-standing electrode, wherein electrolyte is deposited in or on a flexible self-standing electrode, according to some embodiments of the present disclosure.

FIG. 8 shows immersion of a flexible self-standing electrode into a gel or liquid electrolyte in a non-limiting illustration.

FIG. 9 is a flow diagram illustrating an example apparatus for making a self-standing electrode according to an embodiment of the present disclosure.

FIG. 10 illustrates a non-limiting example of an apparatus wherein electrolyte can be introduced before, during, or after formation of a flexible self-standing electrode.

FIG. 11 is a schematic view illustrating a vessel that can be used for dispersion according to an embodiment of the present disclosure.

FIG. 12 shows flexible self-standing electrodes as collected from a porous surface or substrate.

FIG. 13 shows flexible self-standing electrodes after treating (or pressing) to increase the density.

FIG. 14 is a magnified side view of a treated self-standing electrode with flexibility shown by an uplifted corner of the electrode.

FIG. 15 is a magnified overhead view of the treated flexible self-standing electrode with a scale bar of 1 micron shown.

FIG. 16 is a non-limiting example of various components that can be integrated into the flexible battery pouch cells or into the flexible lithium ion battery according to various embodiments of the present disclosure.

FIG. 17A is a scanning electron microscope (SEM) image of self-standing cathodes consisting of LiNMC particles and 1.5 wt % single-wall [carbon] nanotubes (SWNTs), as described in the Examples.

FIG. 17B is an SEM image of self-standing cathodes consisting of LiNMC particles and 1.5 wt % SWNTs, as described in the Examples.

FIG. 17C is an optical image of cathode sheets, as described in the Examples.

FIG. 17D is an SEM image of self-standing anodes consisting of graphite particles and 11 wt % SWNTs, as described in the Examples.

FIG. 17E is an SEM image of self-standing anodes consisting of graphite particles and 11 wt % SWNTs, as described in the Examples.

FIG. 17F is an optical image of anode sheets, as described in the Examples.

FIG. 17G is a typical TEM image of grown SWNTs, as described in the Examples.

FIG. 18A shows a powder density vs. pressure curve for a composite with 1.1 wt % SWCN, as described in the Examples.

FIG. 18B shows a resistivity curve for a composite with 1.1 wt % SWCNT, as described in the Examples.

FIG. 18C shows the conductivity of compressed powder pellets depending on SWNT wt %, as described in the Examples.

FIG. 18D shows conductivity dependence on SWNT wt % for self-standing composite sheets at low concentration ranges of nanotubes, as described in the Examples.

FIG. 19A shows a stress-strain curve for cathode material sheets with 0.9 wt % SWNT, specifically the evolution of hysteresis during twenty-five times strain cycling, as described in the Examples.

FIG. 19B shows a stress-strain curve for cathode material sheets with 0.9 wt % SWNT, specifically the hysteresis after the first and twenty-fifth strain cycling, as described in the Examples.

FIG. 19C shows a stress-strain curve for Cu and Al foils and self-standing sheets with 1.8 wt % SWNT, 0.9 g/cm³ (boldest line), and 3.6% wt % SWCNT, 0.74 g/cm³ (thin line), as described in the Examples.

FIG. 20A shows changes in relative resistance during cyclic stretching, as described in the Examples.

FIG. 20b shows changes in relative resistance during cyclic stretching, as described in the Examples.

FIG. 20C shows changes in relative resistance during cyclic stretching, specifically the first stretching cycle as a function of the sample density, as described in the Examples.

FIG. 20D shows changes in relative resistance during cyclic stretching, specifically the last stretching cycle as a function of the sample density, as described in the Examples.

FIG. 21A shows performance of a single cathode (1.4% CNT) and single anode cell, as described in the Examples.

FIG. 21B shows the normalized discharge capacity of a single cathode (2.3% CNT) and double anode cell, as described in the Examples.

FIG. 21C shows a discharge capacity of the cells normalized to the capacity of the cell during the first full discharge cycle at 0.2C as a function of the nanotube percent and discharge C-rate, as described in the Examples.

FIG. 21D shows a normalized discharge capacity of flexible full cells (percent of initial value) with collector-free, free-standing cathodes and anodes, as described in the Examples.

FIG. 22A shows a pouch full cell flexible battery powering LED while being bent, as described in the Examples.

FIG. 22B shows a pouch full cell flexible battery powering LED while being bent, as described in the Examples.

FIG. 22C shows a wristband shaped flexible battery powering a commercial smartwatch, as described in the Examples.

FIG. 23 shows an example of a wearable device including a wristband shaped flexible battery.

### DETAILED DESCRIPTION

According to some aspects, the present disclosure is directed to flexible batteries that can take the shape of a wristband, head band, ankle band, chest band, armband, sleeves, or clothing and can be used for powering corresponding smart devices. In some embodiments, the flexible batteries can be wearable or implantable. In various embodiments, the flexible batteries can take almost any shape or form.

According to some aspects, the present disclosure is directed to flexible lithium ion batteries comprising high energy density and associated aspects. In some embodiments, methods of making a flexible lithium ion battery are disclosed. According to some aspects, a flexible battery pouch cell is disclosed, comprising flexible self-standing electrodes with electrolyte contained inside flexible material packaging and flexible battery tabs extending from the flexible battery pouch cell. The flexible battery tabs are conductive and can optionally be connected to other flexible battery pouch cells for applications large or small. The flexible lithium ion battery is not limited and can also comprise processors, various sensors, color indicators, embedded devices, GPS, Wi-Fi, accessibility devices, display screens, LEDs, or audio devices as non-limiting examples. The flexible lithium ion battery can be wearable, implantable, or can be configured for deployment in various environments. In some embodiments, the flexible material packaging of the flexible battery pouch cell can have components or processors imprinted into or embedded, for example, various miniature (microscale, nanoscale) components. The flexible material packaging, the flexible battery tabs, and any interconnecting flexible materials can be mechanically or electrically responsive, powered, mobile, twistable, wearable, implantable, biocompatible, waterproof, thermally insulating, able to hold a fixed shape after being formed to a fixed shape, have the ability to return from a deformed shape (temporary shape) to an original (permanent) shape induced by, for example, response to an environmental change or force applied.

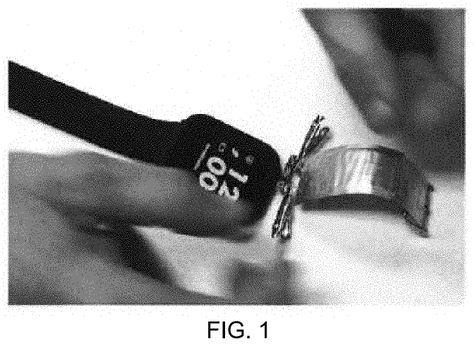

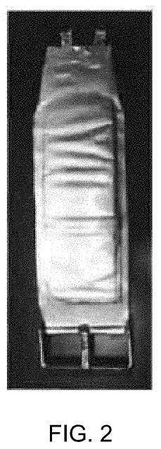

A non-limiting illustration of a flexible battery, in the form of a watch band, according to various embodiments of the present disclosure, is shown in FIG. 1. As shown in FIG. 2, the flexible battery can comprise flexible battery tabs (Top, FIG. 2) extending from the flexible battery pouch cells, and the flexible battery in this non-limiting example comprises a buckle at the bottom of FIG. 2.

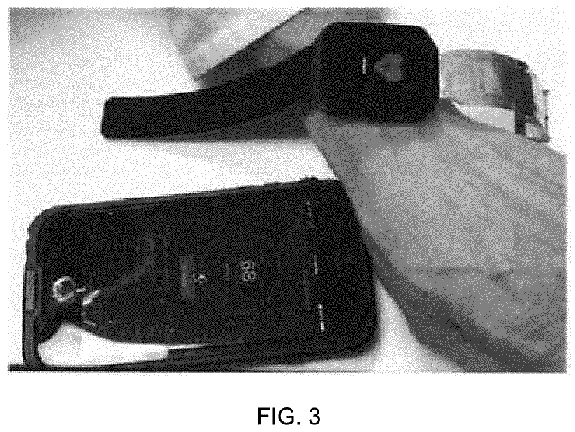

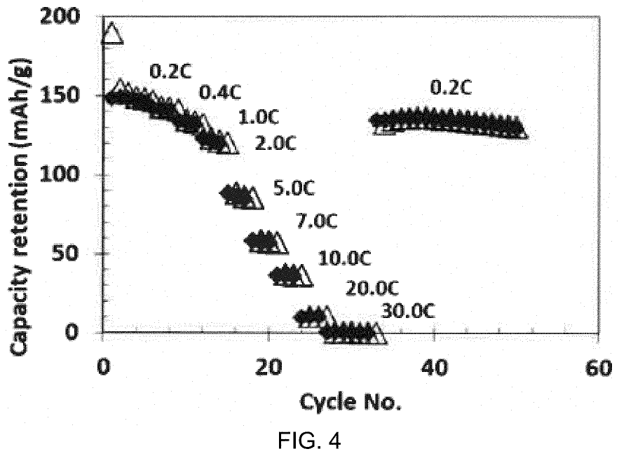

To further illustrate embodiments of the present disclosure, FIG. 3 shows a flexible band battery connected to a smart watch, powering the watch, while heartrate data is transmitted to a smart phone. The high energy density of the flexible battery is illustrated in FIG. 4, wherein a discharge rate of 0.2C has small variance after 40 cycles. The high energy density can be derived from the exclusion of electrochemically inactive components from the flexible battery, for example, current collector, binder, and separator. According to some aspects, the flexible batteries disclosed herein do not comprise current collector, binder, and non-electrochemically active separator. In some embodiments, the electrolyte disclosed herein functions as an electrochemically active separator, further enhancing the high energy density of the flexible lithium ion battery.

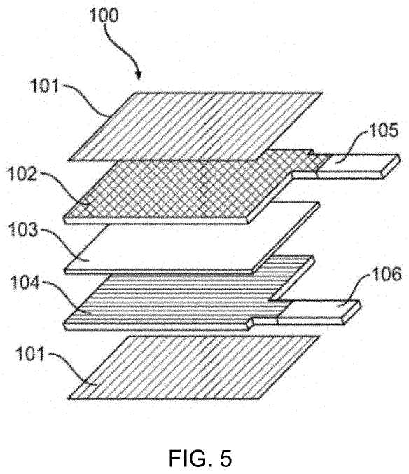

In a non-limiting example as shown in FIG. 5, a flexible battery pouch cell (unit, 100) is expanded to show a flexible material packaging 101 a flexible self-standing anode 102 comprising a battery tab attached 105, which can be flexible; a flexible self-standing cathode 104, comprising a battery tab attached 106, which can be flexible. A solid or gel electrolyte 103 is illustrated between the anode and cathode. A solid electrolyte can eliminate the need for an electrochemically inactive separator membrane as there is no free liquid (in the solid electrolyte) to create a short in pathways between the anode and cathode. It should be understood that the battery tabs shown in FIG. 5 can be in any configuration or place of attachment. In some embodiments, non-flexible battery tabs 105 and 106 can be connected to further extending flexible battery tabs. In some embodiments, battery tabs 105 and 106 can be flexible.

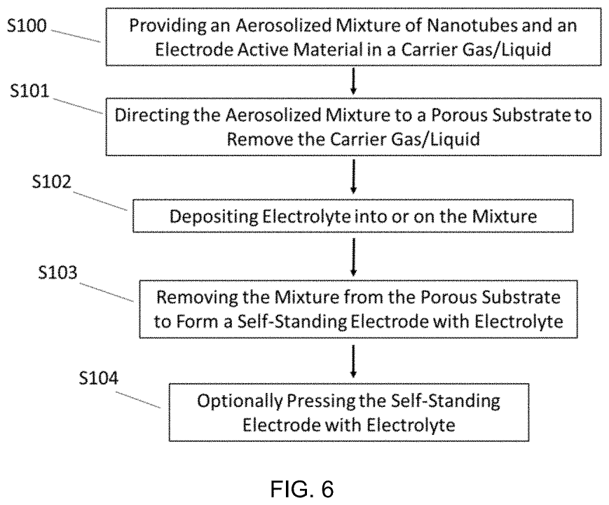

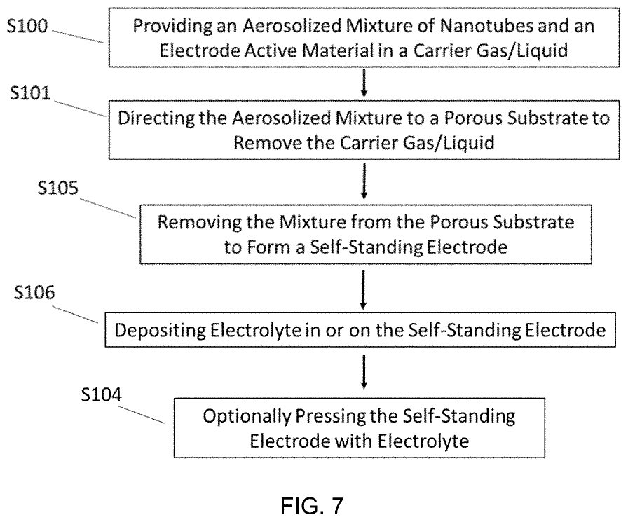

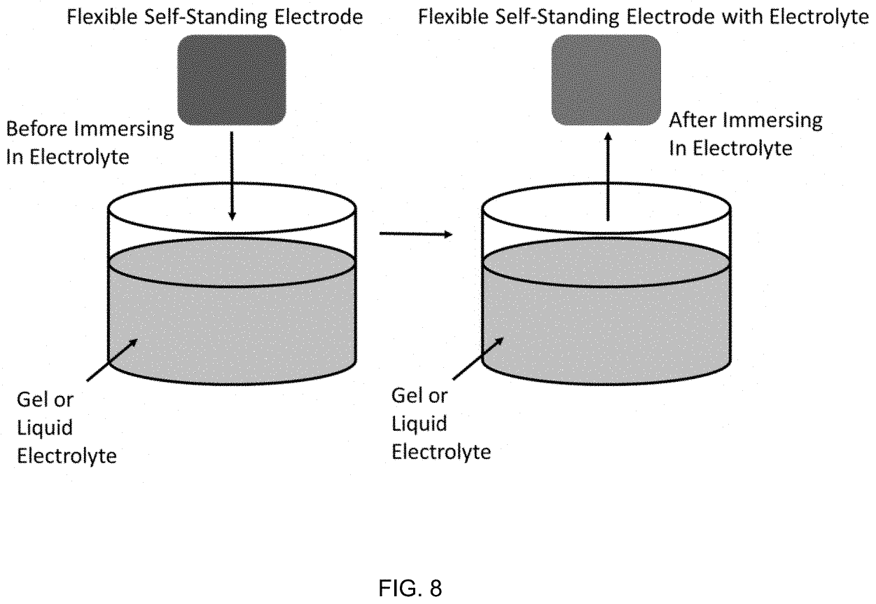

According to some aspects, methods of making flexible self-standing electrodes are disclosed (FIGS. 6-7), wherein a solid electrolyte with high ionic conductivity can be introduced either by, for example, coating (depositing), or immersing in the case of gel, (FIG. 8) on or into the surface of the corresponding flexible self-standing electrodes optionally followed by pressing two electrodes together. Optionally, each electrode can be pressed separately. The electrolyte can be introduced by any suitable means, for example, and can be added to the flexible battery pouch cell after assembly. Currently, there are different types of Li-ion solid electrolytes, for example, NASICON, garnet, perovskite, LISICON, LiPON, Li3N, sulfide, argyrodite, or anti-perovskite. In some embodiments, a solid electrolyte can be shape conformable, flexible, and with high ionic conductivity. Polymer based thin (comparable with a thickness of a separator membrane, about 10 microns) electrolytes are feasible for this purpose. It should be understood that the flexible self-standing electrodes can be treated by various methods, and pressing is used herein as a non-limiting example of a mechanical treatment. In some embodiments, no electrolyte is added or introduced during production of flexible self-standing electrodes, and a non-electrochemically active separator membrane is utilized.

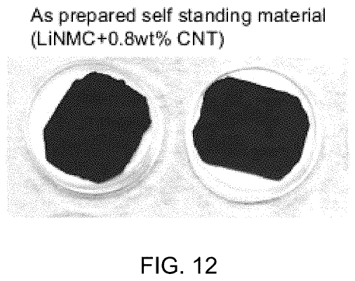

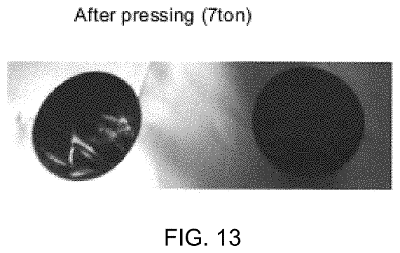

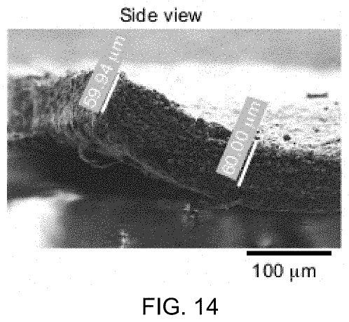

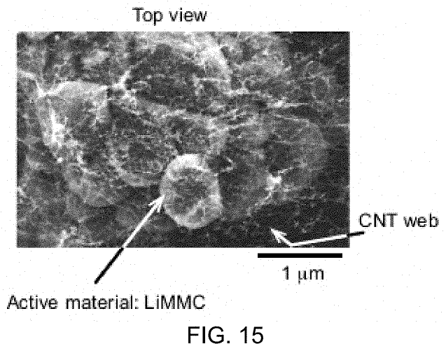

In a non-limiting example as shown in FIG. 6, self-standing electrodes for Li-ion batteries are prepared by providing an aerosolized (or fluidized/dispersed) mixture of carbon nanotubes and electrode active materials at step S100 and directing the aerosolized mixture to a porous substrate at step S101 to form a composite of self-standing electrode material of a desired thickness thereon that comprises the mixed carbon nanotubes and the electrode active materials upon the porous substrate. Electrolyte is deposited, by any means, upon the composite at step S102. Optionally, electrolyte can be dispersed at step S100. The mixture is removed from the porous substrate at step S103, to form a flexible self-standing electrode with electrolyte (FIG. 12). Optionally, the self-standing electrode can be treated at step S104 to, for example, increase the density of the self-standing electrode (FIG. 13). The self-standing electrode is self-supported, flexible, and can optionally be cut to the desired dimensions and shapes of a battery electrode (FIG. 14). The self-standing electrode is optionally free of binder, optionally free of separator, and optionally can be used without a metal-based current collector (typically alumina or copper depending on the electrode type). As shown in FIG. 15, a magnified view of the flexible self-standing electrode (scale bar=1 micron), a carbon nanotube webbed morphology comprises electrode active material and interconnected spaces for electrolyte, while the carbon nanotube web morphology enables various aspects, for example, flexibility of the self-standing electrode.

It should be understood that various examples of methods for production of flexible self-standing electrodes disclosed herein (FIGS. 6-7) do not significantly degrade the length or aspect ratio of the carbon nanotubes during formation of the flexible self-standing electrodes at least due to the non-destructive aerosolizing and deposition steps. The length and aspect ratio of the carbon nanotubes enable to carbon nanotubes to overlay in a webbed morphology during formation of the flexible self-standing electrode contributing to final flexibility and other aspects. As used herein, “significantly degrade the length or aspect ratio” means reducing the length or aspect ratio to less than 50% of length.

In a non-limiting example as shown in FIG. 7, self-standing electrodes for Li-ion batteries are prepared by providing an aerosolized mixture of carbon nanotubes and electrode active materials at step S100, and directing the aerosolized mixture to a porous substrate at step S101 to form a composite of self-standing electrode material of a desired thickness thereon that comprises the mixed carbon nanotubes and the electrode active materials upon the porous substrate. The mixture is removed from the porous substrate at step S105, to form a flexible self-standing electrode. Electrolyte is deposited, by any means, upon or in the flexible self-standing electrode at step S106. Optionally, the self-standing electrode can be treated at step S104 to, for example, increase the density of the self-standing electrode. As shown in the non-limiting example of FIG. 8, immersion can be used to deposit electrolyte. In various embodiments, electrolyte can be introduced by any suitable method and at any stage of production. The self-standing electrode is self-supported, flexible, and can optionally be cut to the desired dimensions of a battery electrode. The self-standing electrode is optionally free of binder, optionally free of separator, and optionally can be used without a metal-based current collector (typically alumina or copper depending on the electrode type).

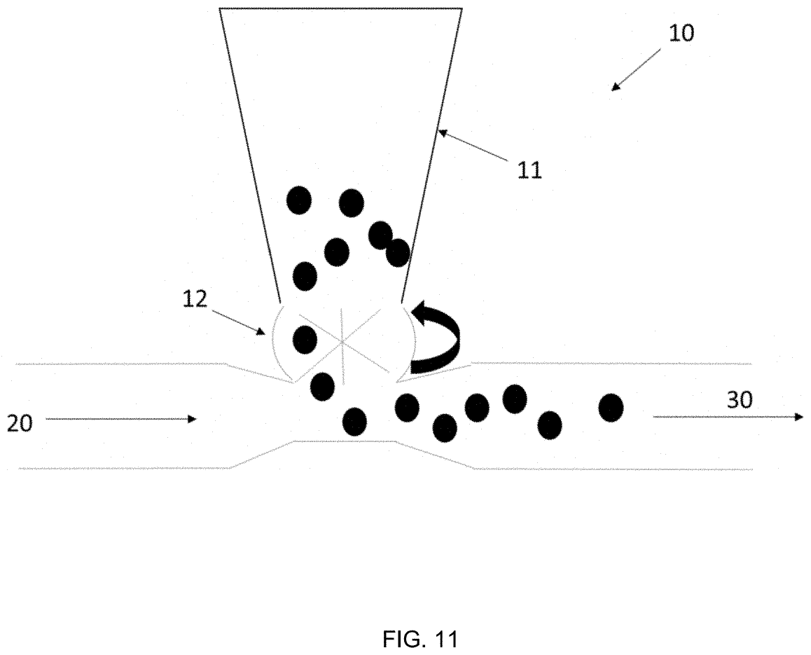

The apparatus for providing the aerosolized (or fluidized/dispersed) mixture of carbon nanotubes and electrode active materials, either separately or combined, with or without electrolyte, is not limited in any way. In an illustrative example as shown in FIG. 11, a vessel 10 may be a pneumatic powder feeder, such as a venturi feeder that includes a hopper 11 for receiving the nanotubes and the electrode active material therein. The vessel 10 may also include a rotary valve 12 that feeds the nanotubes and the electrode active material into contact with a carrier gas 20 that is introduced to the vessel 10 to form the mixed aerosolized stream 30. According to some aspects, more than one vessel 10 may be utilized to combine nanotubes and electrode active material (either separately or pre-combined) into various carrier gases or gas streams. In some embodiments, an electrolyte can be dispersed, aerosolized, or fluidized separately or with the nanotubes and electrode active material. In some embodiments, the nanotubes and the electrode active material can be individually aerosolized before mixing and combined with an electrolyte upon a porous substrate.

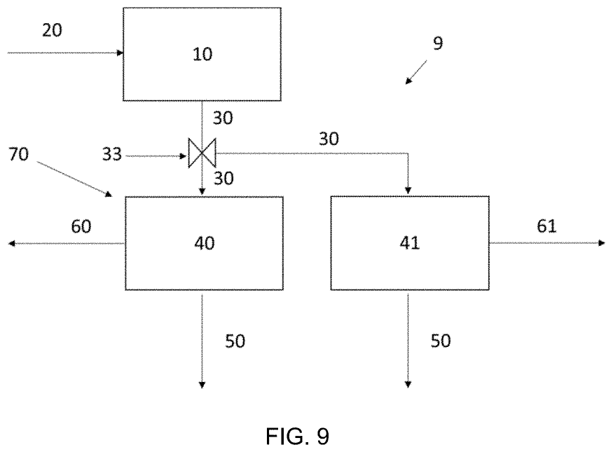

In a non-limiting example as shown in FIG. 9, an apparatus 9 for the production of self-standing electrodes is provided. The carbon nanotubes and the electrode active materials are added to a vessel 10. The carbon nanotubes and the electrode active materials may be individually collected from their respective manufacturing processes and directly or indirectly introduced from such processes into the vessel 10 at a desired ratio for a self-standing electrode. One or more carrier gases 20 may then be introduced to the vessel 10 to aerosolize the mixture of the nanotubes and electrode active materials. The resulting mixed aerosolized stream 30 comprising the nanotubes and the electrode active materials entrained in the carrier gas is directed to a porous substrate 40, such as a filter. The carrier gas passes through the porous substrate 40 as gas stream 50 while the mixture of the nanotubes and the electrode active material is captured on the surface of the porous substrate 40 to form the self-standing electrode 60 upon the porous surface. Any electrolyte, 70, can be introduced either before, during, or after the flexible self-standing electrode (upon the porous substrate) forms. The self-standing electrode 60 can be removed from the porous substrate 40 when it reaches the desired thickness to form the flexible self-standing electrode.

Optionally, the apparatus 9 (FIG. 9) may include a plurality of porous substrates 40, 41 to allow for the continuous production of self-standing electrodes 60, 61 upon porous surfaces. Although only two porous substrates are shown, it is to be understood than any number of porous substrates may be included in the apparatus 9. In a non-limiting example, when the flow of the mixed aerosolized stream 30 across the porous substrate 40 produces the self-standing electrode 60 of the desired thickness, a valve 33 may be adjusted to transfer the flow of the mixed aerosolized stream 30 to a second porous substrate 41. The self-standing electrode 60 may be removed from the first porous substrate 40 during formation of the self-standing electrode 61 on the porous substrate 41. When the flow of the mixed aerosolized stream 30 across the second porous substrate 41 produces the self-standing electrode 61 of a desired thickness, the valve 33 may be adjusted to transfer the flow of the mixed aerosolized stream 30 back to the first porous substrate 40. The thickness and/or cross-sectional area of the self-standing electrode 61 may be the same, or different, than the cross-sectional area of the self-standing electrode 60. For example, the self-standing electrode 61 may have a greater thickness and/or cross-sectional area than the self-standing electrode 60.

It is to be understood that a variety of different methods may be used for automatically switching the valve 33 to redirect the flow of the mixed aerosolized stream 30 from one porous substrate to the other. Illustrative examples of systems that may be used to adjust the valve 33 to redirect the flow of the mixed aerosolized stream 30 include one or more sensors for detecting the thickness of the self-standing electrodes 60 and 61, one or more pressure sensors for monitoring a pressure drop across the porous substrates 40 and 41 that corresponds to a desired thickness of the self-standing electrodes 60 and 61, a timer that switches the valve 33 after a set time corresponding to a desired thickness of the self-standing electrodes 60 and 61 for a given flow rate of the mixed aerosolized stream 30, and any combination thereof; after the one or more pressure sensors measures a pressure drop associated with the desired thickness of the self-standing electrode 60 or 61 on porous substrate 40 or 41, or after the one or more thickness sensors detect the desired thickness of the self-standing electrode 60 or 61 on porous substrate 40 or 41, or after the timer measures the set time corresponding to the desired thickness of self-standing electrode 60 or 61 on porous substrate 40 or 41, the mixture is redirected from one porous substrate to the other. It is to be understood that the introduction of an electrolyte, 70, can be metered along with formation of the self-standing electrode upon the porous surface or thereafter. It is also to be understood that the porous substrates 40 and/or 41 may have a cross-sectional area that matches the desired cross-sectional area required for use in the battery cell to be made with the self-standing electrode 60 and/or 61. Accordingly, the flexible self-standing electrodes 60 and/or 61 would require no further processing of the cross-sectional area, such as cutting, before assembly in the final battery cell. In some embodiments, the flexible self-standing electrodes can be cut, treated, or further assembled, for example, battery tabs can be attached or electrolyte can be introduced after production.

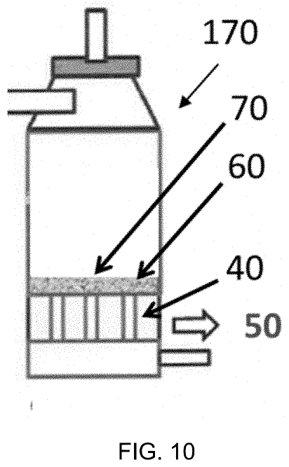

As shown in a non-limiting example in FIG. 10, the electrolyte 70 may be provided before, during, or after the formation of the self-standing electrode 60 upon the porous substrate 40 with gas stream 50 exiting the collection area 170. In some embodiments, the mixture is removed from the porous substrate 40, to form the flexible self-standing electrode. It should be understood that in the various embodiments and non-limiting examples disclosed herein, introduction of an electrolyte at any step is optional, and a separator membrane can be used within the flexible battery pouch cells. In some embodiments, an electrolyte can be added to the flexible battery pouch cells after production of the flexible self-standing electrodes.

As an alternative to the specific apparatus noted above where the electrode active material is mixed with the nanotubes after the nanotubes are introduced, the electrode active material can be mixed in situ in a fluidized bed reactor or chamber with the nanotubes as the nanotubes are formed or introduced.

Carrier and fluidizing or aerosolizing gases suitable for use with the present disclosure include, but are not limited to, argon, hydrogen, nitrogen, and combinations thereof. Carrier gases may be used at any suitable pressure and at any suitable flow rate to aerosolize the nanotubes and the electrode active materials and transport the aerosolized mixture of the nanotubes and the electrode active materials to the porous substrate at a sufficient velocity to form the self-standing electrode on the surface thereof. According to some aspects, electrolyte can be fluidized or aerosolized in a carrier gas and combined with carbon nanotubes or electrode active materials. In some embodiments, the carrier gas may be argon, hydrogen, helium, or mixtures thereof.

The type of carbon nanotubes used in the present disclosure are not limited and can be single-walled or multi-walled. The nanotubes may be entirely carbon, or they made be substituted, that it is, have non-carbon lattice atoms. Carbon nanotubes may be externally derivatized to include one or more functional moieties at a side and/or an end location. In some aspects, carbon and inorganic nanotubes include additional components such as metals or metalloids, incorporated into the structure of the nanotube. In certain aspects, the additional components are a dopant, a surface coating, or are a combination thereof.

Carbon nanotubes may be metallic, semimetallic, or semi-conducting depending on their chirality. A carbon nanotube's chirality is indicated by the double index (n,m), where n and m are integers that describe the cut and wrapping of hexagonal graphite when formed into a tubular structure, as is well known in the art. A nanotube of an (m,n) configuration is insulating. A nanotube of an (n,n), or “arm-chair”, configuration is metallic, and hence highly valued for its electric and thermal conductivity. Carbon nanotubes may have diameters ranging from about 0.6 nm for single-wall carbon nanotubes up to 500 nm or greater for single-wall or multi-wall nanotubes. The nanotubes may range in length from about 50 nm to about 10 cm or greater.

Collecting the mixture of single-walled carbon nanotubes and aerosolized electrode active material powder on a surface and removing the carrier gas may be carried out by any suitable means. The collecting surface of the porous substrate 40, 41 (FIG. 9) may be a porous surface, including but not limited to a filter or a frit, where the pores are appropriately sized to retain the mixture of carbon nanotubes and the electrode active material (and electrolyte if added) thereon to form the flexible self-standing electrode while permitting passage of the carrier and fluidizing gases. The carrier and fluidizing gases may be removed after passing through the surface and by way of an outlet. In some embodiments, removal of the carrier gas may be facilitated by a vacuum source. With respect to filters, the filters may be in the form of a sheet and may comprise a variety of different materials including woven and non-woven fabrics. Illustrative filter materials include, but are not limited to, cotton, polyolefins, nylons, acrylics, polyesters, fiberglass, and polytetrafluoroethylene (PTFE). To the extent the porous substrate is sensitive to high temperatures, one or more of the gas streams may be precooled with dilution gases comprising a lower temperature and/or by directing one or more of the streams through a heat exchanger prior to contacting the porous substrate.

The loading or weight % of carbon nanotubes in the flexible self-standing electrode is based on the relative amounts of the nanotubes (or carbon source used to form the nanotubes), the electrode active material, and optionally the electrolyte. It is within the level of ordinary skill in the art to determine the relative starting amounts of carbon source, catalyst/catalyst precursor, optional electrolyte, and electrode active material that will afford a given loading or weight % of carbon nanotubes in the flexible self-standing electrode. In a non-limiting example, the flexible self-standing electrode may comprise from about 0.1% to 4% by weight carbon nanotubes, and the balance the electrode active material and optionally an electrolyte. Optionally, the flexible self-standing electrode may comprise from about 0.2% to 3% by weight carbon nanotubes, or about 0.75% to 2% by weight. The flexible self-standing electrode may be free of any binders. The lack of a binder results in a self-standing electrode with improved flexibility. Further, it has been discovered that a higher carbon nanotube content increases the flexibility of the self-standing electrode. Without being bound to any particular theory, this is likely due to the length and aspect ratio of the carbon nanotubes and webbed morphology of the self-standing electrode comprising a webbed arrangement of carbon nanotubes and interconnected spaces with the electrode active material contained or embedded within the web.

In a non-limiting example, the flexible self-standing electrode may comprise a density of 0.9 to 1.75 g/cc. Optionally, the self-standing electrode may comprise a density of 0.95 to 1.25 g/cc. Optionally, the self-standing electrode may comprise a density of 0.75 to 2.0 g/cc. Optionally, the self-standing electrode may comprise a density of 0.95 to 1.60 g/cc. If the flexible self-standing electrode comprises electrolyte, in some embodiments, the density can change.

In a non-limiting example, the flexible self-standing electrode may comprise a thickness of up to 750 μm following collection on the porous substrate. Optionally, the self-standing electrode may comprise a thickness of 50 μm to 500 μm following collection on the porous substrate. Optionally, the self-standing electrode may comprise a thickness of from 100 μm to 450 μm following collection on the porous substrate. Optionally, the self-standing electrode may comprise a thickness of from 175 μm to 250 μm following collection on the porous substrate.

In some embodiments, the method of the present disclosure may further comprise treating the composite or flexible self-standing electrode, including but not limited to pressing the composite or flexible self-standing electrode. Without wishing to be bound to any particular theory, pressing may increase the density and/or lower the thickness of the self-standing electrode, which may improve such properties as rate performance, energy density, and battery life. Pressing of the self-standing electrodes may be carried out by applying a force to achieve a desired thickness and/or density, such as by using a rolling press or calendaring machine, platen press, or other suitable means, as will be known to those of ordinary skill in the art. Any suitable force may be applied, to achieve a desired thickness, and/or density, and/or impedance, such as but not limited to a force of about 1 ton, about 2 tons, about 3 tons, about 4 tons, about 5 tons, about 6 tons, about 7 tons, about 8 tons, about 9 tons, about 10 tons, about 15 tons, or any integer or range in between, such as between about 7 tons and about 10 tons. In some embodiments, pressing may be limited to pressing to a thickness of about 20 microns, about 30 microns, about 40 microns, about 50 microns, about 60 microns, about 70 microns, about 80 microns, about 90 microns, about 100 microns, about 150 microns, about 200 microns, about 250 microns, about 300 microns, about 350 microns, about 400 microns, or any integer or range in between. Without wishing to be bound by any particular theory, too thick of an electrode may be slow to produce energy or may not be suitably flexible. If the electrode is too thin, energy production may be rapid but it may be the case that not enough energy is produced. In addition, it may be desirable to regulate the distance between the rolls or rollers in a rolling press or calendaring machine, or between the plates of a platen press, by any suitable means known to those of ordinary skill in the art.

Determination of a suitable amount of pressing is within the level of ordinary skill in the art. As will be known to those of ordinary skill in the art, excessive pressing may cause the electrolyte to penetrate the electrode too much, as determined by measuring impedance and/or resistance to diffusion. As will be evident to those of ordinary skill in the art, it may be of interest to minimize the electrolyte diffusion resistance or coefficient for a given electrolyte, as measured by impedance. In a non-limiting example, the thickness of the self-standing electrode following pressing may be from 40% to 75% of the thickness of the untreated self-standing electrode, or the self-standing electrode following collection on the porous substrate. Optionally, the thickness of the self-standing electrode following pressing may be from 45% to 60% of the thickness of the untreated self-standing electrode, or the self-standing electrode following collection on the porous substrate.

In a non-limiting example, the density of the self-standing electrode following pressing is increased by 40% to 125% of the density of the untreated self-standing electrode, or the self-standing electrode following collection on the porous substrate. Optionally, the density of the self-standing electrode following pressing is increased by 45% to 90% of the density of the untreated self-standing electrode, or the self-standing electrode following collection on the porous substrate.

In FIG. 12, flexible self-standing electrode material is shown before treatment. FIG. 13 shows the flexible self-standing electrode material after 7 ton pressing. A side view of the pressed flexible self-standing electrode material, shown in FIG. 14, shows a thickness of about 60 microns and flexibility is illustrated by a lifted corner of the self-standing electrode. FIG. 15 is a magnified view showing a scale of one micron, the active material particles are shown with a carbon nanotube webbed morphology.

In some embodiments, the aerosolizing (or fluidization/dispersion) of the electrode active material comprises distributing an aerosolizing gas through a first porous frit and a bed of an electrode active material, in an aerosolizing chamber, to produce the aerosolized electrode active material powder. The aerosolizing chamber may be constructed with an appropriately sized porous material such that gas can pass through to enable aerosolizing but that does not permit the active material to fall through the pores. The aerosolizing chamber is not limited to any particular configuration. Suitable aerosolizing gases include, but are not limited to, argon, helium, or nitrogen. In some embodiments, the aerosolizing gas may be the same as the carrier gas.

As used herein, “electrode active material” refers to the conductive material in an electrode. The term “electrode” refers to an electrical conductor where ions and electrons are exchanged with an electrolyte and an outer circuit. “Positive electrode” and “cathode” are used synonymously in the present description and refer to the electrode having the higher electrode potential in an electrochemical cell (i.e. higher than the negative electrode). “Negative electrode” and “anode” are used synonymously in the present description and refer to the electrode having the lower electrode potential in an electrochemical cell (i.e. lower than the positive electrode). Cathodic reduction refers to a gain of electron(s) of a chemical species, and anodic oxidation refers to the loss of electron(s) of a chemical species.

In some embodiments, the electrode active material is selected from graphite, hard carbon, metal oxides, lithium metal oxides, and lithium iron phosphate. In some embodiments, the electrode active material for the anode may be graphite or hard carbon. In some embodiments, the electrode active material for the cathode may be lithium metal oxides or lithium iron phosphate.

In a non-limiting example, the electrode active material may be any solid, metal oxide powder that is capable of being aerosolized. In an illustrative example, the metal oxide is a material for use in the cathode of the battery. Non-limiting examples of metal oxides include oxides of Ni, Mn, Co, Al, Mg, Ti and any mixture thereof. The metal oxide may be lithiated. In an illustrative example, the metal oxide is lithium nickel manganese cobalt oxide, Li(Ni,Mn,Co)O₂, Li—Ni—Mn—Co—O, (LiNiMnCoO₂), or (LiNiₓMn_{y}Co_{z}O₂, x+y+z=1). The metal oxide powders can have a particle size defined within a range between about 1 nanometer and about 100 microns. In a non-limiting example, the metal oxide particles have an average particle size of about 1 nanometer to about 10 nanometers.

According to some aspects, a solid electrolyte with high ionic conductivity can be introduced either by, for example, coating (depositing) (or immersing in the case of gel or liquid, FIG. 8) on the surface of the self-standing electrodes optionally followed by pressing two electrodes together. Optionally, each self-standing electrode can be pressed before combining with another self-standing electrode. As used herein, various descriptions of introduction of an electrolyte are non-limiting, as an electrolyte can be introduced at any stage or by any means to provide the self-standing electrode, the flexible pouch battery cell, the flexible battery, or components thereof. Currently, there are different types of Li-ion solid electrolytes, for example, NASICON, garnet, perovskite, LISICON, LiPON, Li3N, sulfide, argyrodite, or anti-perovskite. In some embodiments, the solid electrolyte can be shape conformable, flexible, and with high ionic conductivity. Polymer based thin (comparable with a thickness of a separator membrane, about 10 microns) electrolytes are feasible for this purpose. According to some aspects, polymer based thin electrolytes utilized in the present disclosure can optionally be about 5-40 microns thick, about 10-30 microns thick, about 15-25 microns thick, or about 20 microns thick. In some embodiments, a liquid electrolyte is utilized, and a separator membrane, not performing the role of an electrolyte, can be about 5-40 microns thick, about 10-30 microns thick, about 15-25 microns thick, or about 20 microns thick.

It should be understood that, as used herein, flexible battery pouch cells (battery cells or units) can comprise two or more self-standing electrodes, and one or more units can be combined to provide a flexible lithium ion battery (FIGS. 1-3). According to some aspects, battery cells without separator membranes or a polymer based insulator membrane are disclosed herein, and a solid (gel) electrolyte with high ionic conductivity, for example, a polymer based gel electrolyte can be used in the role of a separator while simultaneously performing the role of an electrolyte. Thus, the energy density of the flexible battery pouch cells can be increased. According to some aspects, the battery cells have a high energy density and are free of binder, current collector, and separator. In some embodiments, the battery cells can be connected together in parallel, series, or other configurations.

As used herein, “current collector” refers to a metal based current collector, for example, copper or aluminum current collectors, as foils or sheets, utilized in lithium ion batteries. The term “free of current collector” refers to an electrode or self-standing electrode without a metal based current collector. As used herein, “separator” or “separator membrane” refers to a permeable membrane that provides a barrier between the anode and the cathode while enabling the exchange of lithium ions from one side to the other but that does not function as an electrolyte. For example, a polymer that is not functioning as an electrolyte is referred to herein as a “separator membrane”. As used herein, the term “free of separator” and “free of separator membrane” refers to a lithium ion battery that is free of a non-electrolyte separator. According to the various embodiments herein, flexible lithium ion batteries are disclosed herein that are free of separator membrane, free of current collector, and free of binder.

The flexible battery pouch cells disclosed herein are flexible due, independently, to the flexible and self-standing electrodes, the flexible material packaging, and the attached battery tabs, which are optionally flexible. The flexible material packaging surrounding each battery cell can be made of any suitable material and can be, in non-limiting examples, twistable, wearable, implantable, biocompatible, waterproof, thermally insulating, able to hold a fixed shape after being formed to a fixed shape, have the ability to return from a deformed shape (temporary shape) to an original (permanent) shape induced by, for example, response to an environmental change or force applied. In some embodiments, the flexible material packaging can have devices imprinted upon it, embedded in it, or attached to it, for example, environmental sensors, LEDs, processors, displays, bio-sensors, and connectivity such as GPS and Wi-Fi, while these non-limiting examples can alternatively be integrated into the entire flexible lithium ion battery or any portions thereof. According to some aspects, the flexible material packaging is sealed by any suitable means to contain the flexible self-standing electrodes (and electrolyte, electrode active material, battery tab attachments to the electrodes) therein. In some embodiments, the flexible lithium ion battery can surround a device, can be an integration platform for a device, can be detachable from a device, can be internal or external to a device, with a device comprising, for example, a processor, circuitry, and electrical components.

The battery tabs can be attached to or embedded in the flexible self-standing electrodes by any means. In some embodiments, the battery tabs can be flexible. In some embodiments, the battery tab can comprise a different material at or near the area of attachment to the flexible self-standing electrode and a different material external to the flexible battery pouch cell or extending from the flexible self-standing electrode. In some embodiments, a battery tab can be inflexible at or near the point of attachment to a flexible self-standing electrode, and a flexible further extending battery tab can be attached to the inflexible battery tab, extending flexibly away from the flexible self-standing electrode. In some embodiments, the entire battery tab can be flexible. In some embodiments, the entire battery tab can be inflexible.

As shown in the top of FIG. 2, a flexible battery pouch cell can have battery tabs extending for various applications. The configuration in FIG. 2 is non-limiting as the battery tabs can, in some embodiments, extend from any surface of the flexible battery pouch cell. In some embodiments, no battery tabs extend from the flexible battery pouch cell, for example, if a device is contained within or upon the flexible battery pouch cell.

According to some aspects, the flexible lithium ion battery (cell) is bridged together with one or more other flexible lithium ion batteries. The bridging between flexible lithium ion batteries can comprise a material such as a polymer film, rubber, resin, silicon straps, metallic springs, or any other suitable bridging components. Depending on various applications, the battery cells can be connected by serial, parallel, or other electrical combinations. The battery cells can be described as units. According to some aspects, the units can be bridged in various 2D or 3D configurations to form overall shapes for different applications.

According to some aspects, the units can be bridged in almost any final shape or configuration. It should be understood that as used herein, “bridged” and “bridging” refers to a connection between units and comprises battery tabs, for example, as shown in FIG. 2, optionally with a flexible material. The battery tabs shown in FIGS. 2 and 5 can be attached to or embedded in any part of the self-standing electrodes. It should be understood that the battery tabs are not current collectors as used herein. To form the flexible lithium ion battery, the battery tabs can be any suitable material that is conductive and optionally flexible.

According to some aspect, the flexible batteries shown in FIGS. 1-3 can be of any size or shape, and the flexible material packaging can be any suitable material to contain the flexible self-standing electrodes while enabling the battery tabs, if required, to extend therefrom. The flexible self-standing electrodes can be folded one or more times before placement inside the flexible material packaging. In some embodiments, the flexible material packaging is sealed using heat, adhesive, laminate, and various treatments to form the flexible battery pouch cell. The bridging between or among units can be accomplished with any suitable material, with the conductive battery tabs comprising any suitable material for electrically connecting the flexible batteries to devices or in series, parallel, or combinations suitable for various applications, voltages, or configurations.

FIGS. 2 and 5 show non-limiting examples of a flexible battery pouch cell with battery tabs extending. Battery tabs can be attached to the electrodes, in accordance with aspects of the present disclosure, either to protrusions extending from the main body of the respective electrode and not overlapping with the other electrode; or to the main body of the respective electrode at cutouts of the separator membrane and the opposing electrode. According to some aspects, battery tabs are embedded into the electrodes. Suitable battery tab materials and methods of attachment include those known to persons of ordinary skill in the art. In some embodiments, the battery tabs can comprise copper or lead for the anode. In some embodiments, the battery tabs can comprise aluminum or lead for the cathode. According to some aspects, the battery tabs can comprise one metal at or near attachment to the electrode and a different metal extending away from the electrode, for example, a flexible metal.

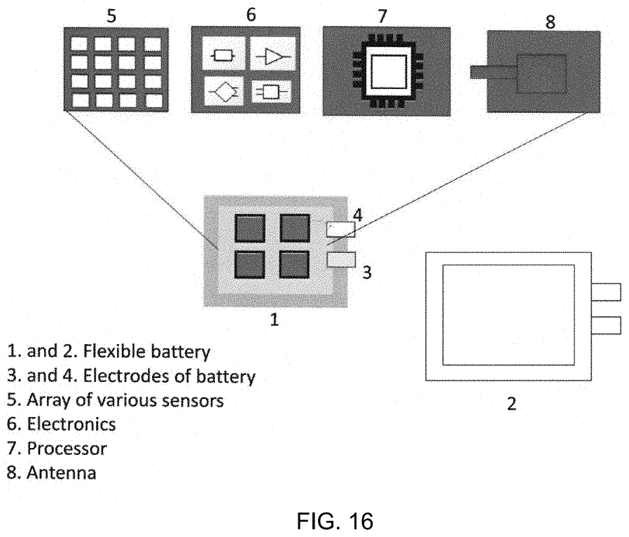

According to some aspects, as shown in the non-limiting illustration in FIG. 16, the flexible lithium ion batteries disclosed herein or the flexible battery pouch cells can comprise, for example, sensors, electronics, processors, antennae, and various other components. According to some aspects, the surface of the flexible material packaging can be used as a substrate to attach, print, and/or embed electronic devices. Non-limiting examples of suitable electronic devices include various types of sensors, microprocessors, wireless communication devices/transmitting devices (e.g. Wi-Fi), circuit boards, and other electronics (e.g. accelerometer, gyroscope). Examples of suitable sensors include those for detecting heart rate, respiratory rate, blood pressure, blood oxygen saturation, body temperature, muscle activity, seizure events, electroencephalography (EEG), epileptic crises, electroencephalogram (ECG), electromyographic data (EMG), and electrodermal activity (EDA). Additional examples of suitable sensors include those for monitoring concentrations of pollutants and movement of objects. In one embodiment, the wearable devices integrated with flexible batteries have a wide range of applications including monitoring environmental pollution, space exploration, homeland security, biology, implants, and medicine. In an embodiment, an application of wearable sensors/devices is real time monitoring of human physiological parameters.

According to some aspects, the flexible self-standing electrodes disclosed herein can be in the form of a thread or thread like textile. In some embodiments, the flexible lithium ion battery can be in the form of a woven textile, or the flexible material packaging can be in the form of a woven textile. According to some aspects, the battery tabs can be in the form of a fabric, textile, or elastic.

According to some aspects, a flexible lithium ion battery is disclosed, comprising: an external flexible material packaging containing two or more flexible self-standing electrodes, each flexible self-standing electrode comprising one or more battery tabs attached to each flexible self-standing electrode; wherein each battery tab comprises an electrically conductive material; wherein each battery tab extends from each flexible self-standing electrode through the flexible material packaging and further extends external to the flexible material packaging of the flexible battery pouch cell; and wherein each flexible battery tab is operative to connect a flexible battery pouch cell to a device or to other flexible battery pouch cells.

According to some aspects, the flexible material packaging can comprise flexible polymer, foil, rubber, fabric, biocompatible material, organic material, material with components and processors embedded in and imprinted upon the flexible material packaging, and combinations thereof. The flexible lithium ion battery can comprise a processor, an electronic device, a sensor, a receiver, a transmitter, an audio device, and a display. In some embodiments, the flexible lithium ion battery can comprise one or more joints the areas where battery tabs or optional flexible materials traverse external to the flexible battery pouch cells.

In some embodiments, a method of making a flexible lithium ion battery is disclosed, the method comprising the steps: (a) providing one or more flexible self-standing electrodes; (b) attaching one or more battery tabs to each flexible self-standing electrode; (c) placing one or more flexible self-standing electrodes inside a flexible battery pouch cell, with one or more battery tabs optionally extending external to the flexible battery pouch cell; (d) sealing the flexible battery pouch cell; to form a unit of flexible battery pouch cell; and (e) connecting the battery tabs external to the flexible battery pouch cell to a device or optionally to another flexible battery pouch cell. The method can further comprise the addition of one or more components comprising processors, sensors, transmitters, receivers, displays, a light emitting device, and an audio device into or upon the flexible battery pouch cell. In some embodiments, the flexible lithium ion battery can be integrated with an electronic device, the electronic device comprising a processor, sensor, transmitter, receiver, display, GPS, audio, and mobile device.

In various embodiments, any method disclosed herein can be recited in the claims or claimed in steps, for example, step a, step b, step c, step d, and subsequent steps as needed or step 1, step 2, step 3, step 4, and subsequent steps as needed. For example, according to some aspects, a method of making a flexible lithium ion battery is disclosed herein, the method comprising the steps: (a) providing one or more flexible self-standing electrodes with conductive battery tabs extending from one or more flexible self-standing electrodes; (b) containing one or more flexible self-standing electrodes inside a flexible battery pouch cell, with one or more conductive battery tabs extending external to the flexible battery pouch cell; and (c) optionally adding an electrolyte. According to some aspects, steps can be added or deleted in any way, for example, the method steps (a)-(c) above may further comprise adding a separator or may further comprise, for example, adding a processor. In some embodiments, the method (a)-(c) or any method disclosed herein can further comprise the addition of one or more electronic components to any element of the flexible lithium ion battery. If steps are recited in the claims, overall changes, additions, or deletions can be recited in subsequent claims, as it should be understood that the present disclosure is not limited by the examples provided herein.

According to some aspects, a flexible lithium ion battery is disclosed herein, comprising: two or more flexible self-standing electrodes, each flexible self-standing electrode comprising one or more conductive battery tabs attached to and extending from each flexible self-standing electrode; flexible material packaging operative to contain the two or more flexible self-standing electrodes; wherein the conductive battery tabs extend from the flexible self-standing electrodes through the flexible material packaging and external to the flexible material packaging. The conductive battery tabs can be flexible. The flexible lithium ion battery can be free of current collector, free of binder, or free of both current collector and binder, and the battery can comprise a solid electrolyte between each of the two or more flexible self-standing electrodes; the solid (or gel) electrolyte can take the place of a non-electrochemically active separator (membrane). In some embodiments, a liquid electrolyte is used, and a non-electrochemically active separator membrane is utilized. The flexible lithium ion battery can further comprise extending flexible battery tabs attached to the one or more conductive battery tabs attached to and extending from each flexible self-standing electrode. In some embodiments, each flexible self-standing electrode can comprise: a plurality of carbon nanotubes arranged in a webbed morphology with interconnected spaces among the carbon nanotubes, the interconnected spaces comprising: an electrode active material and an electrolyte. The flexible material packaging can comprise one or more layers selected from flexible polymer, foil, rubber, fabric, biocompatible material, organic material, material with components and processors embedded in and imprinted upon the flexible material packaging, and combinations thereof. According to some aspects, the flexible lithium ion battery is free of a separator, free of a current collector, and free of a binder, and has a high energy density due to the lack of non-electrochemically active components. In some embodiments, a method of making a flexible lithium ion battery is disclosed herein, the method comprising the steps: (a)providing two or more flexible self-standing electrodes with conductive battery tabs extending from the flexible self-standing electrodes; and (b) containing two or more flexible self-standing electrodes inside a flexible battery pouch cell, with the conductive battery tabs extending external to the flexible battery pouch cell; to form a flexible lithium ion battery. A solid (or gel) electrolyte can be added between each of the two or more flexible self-standing electrodes. The method can further comprise attaching extending battery tabs to the conductive battery tabs extending from the flexible self-standing electrodes, the extending battery tabs comprising a flexible material. As used herein, “free of separator” can comprise an electrolyte operative as a separator and means free of a separator that is an electrochemically inactive component, for example. In some embodiments, the electrolyte can function as an electrochemically active separator. The electrolyte, in some embodiments, can have a thickness from about 10 microns to 20 microns.

According to some aspects, the flexible lithium ion battery can comprise conductive battery tabs; the conductive battery tabs comprise spring metal, conductive polymer, and carbon nanotubes.

According to some aspects, a method of making a flexible lithium ion battery is disclosed herein, the method comprising the steps: (a) providing one or more flexible self-standing electrodes with conductive battery tabs extending from one or more flexible self-standing electrodes; and (b) containing one or more flexible self-standing electrodes inside a flexible battery pouch cell, with one or more conductive battery tabs extending external to the flexible battery pouch cell, to form a flexible lithium ion battery. The method can comprise adding an electrolyte, the electrolyte operative as an electrochemically active separator, at any step or stage of making.

In some embodiments, the methods disclosed herein can further comprise the addition of one or more components comprising processors, sensors, transmitters, electronics, receivers, displays, a light emitting device, and an audio device into or upon the flexible lithium ion battery. The flexible lithium ion battery can be integrated with an electronic device, the electronic device comprising a processor, sensor, transmitter, receiver, display, GPS, audio, and mobile device. In some embodiments, a method of using a flexible lithium ion battery is disclosed herein, the method can comprise wearing (externally or implanted) the flexible lithium ion battery for longer than 24 hours, optionally longer than 48 hours, optionally longer than 72 hours, and optionally longer than 7 days.

According to some aspects, a method of using a flexible lithium ion battery is disclosed herein, the method comprising: attachment of the flexible lithium ion battery to an electronic device; wherein the shape of the flexible lithium ion battery and the attachment to an electronic device is ergonomic and wearable; and the flexible properties of the lithium ion battery are operative to a wearable comfort of the flexible lithium ion battery.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. No claim element is to be construed as a means plus function unless the element is expressly recited using the phrase “means for.”

This detailed description uses examples to present the disclosure, including the example aspects and variations, and also to enable any person skilled in the art to practice the disclosed aspects, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Aspects from the various embodiments described, as well as other known equivalents for each such aspect, can be mixed and matched by one of ordinary skill in the art to construct additional embodiments and techniques in accordance with principles of this application.

Reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference.

Herein, the recitation of numerical ranges by endpoints can include all numbers subsumed within that range, for example, between about 20 minutes and 40 minutes includes 21, 22, 23, and 24 minutes as endpoints within the specified range. Thus, for example, ranges 22-36, 25-32, 23-29, etc. are also ranges with endpoints subsumed within the range 20-40 depending on the starting materials used, specific applications, specific embodiments, or limitations of the claims if needed. The Examples and methods disclosed herein demonstrate the recited ranges subsume every point within the ranges because it is disclosed that various products can result from changing one or more endpoints. Further, the methods and Examples disclosed herein describe various aspects of the disclosed ranges and the effects if the ranges are changed individually or in combination with other recited ranges.

As used herein, the term “about” and “approximately” are defined to being close to as understood by one of ordinary skill in the art. In one non-limiting embodiment, the term “about” and “approximately” are defined to be within 10%, preferably within 5%, more preferably within 1%, and most preferably within 0.5%.

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

The examples are put forth so as to provide those of ordinary skill in the art with a complete disclosure and description of how to make and use the present invention, and are not intended to limit the scope of what the inventors regard as their invention nor are they intended to represent that the disclosure is in any limited by the examples provided. Efforts have been made to ensure accuracy with respect to numbers used (e.g. amounts, dimensions, etc.) but some experimental errors and deviations should be accounted for.

### EXAMPLES

### Example I(a): Preparation of Self-Standing Composite Electrode

The apparatus for preparing the self-standing composite electrode included a reactor for the synthesis of SWNTs, a chamber for generating aerosolized active material powder that is in fluidic communication with a mixing chamber for mixing with SWNTs, and a chamber for co-deposition of SWTs and active material mixture.

SWNTs were grown at ambient pressure via a floating catalyst CVD method using ferrocene and ethanol as the catalyst and carbon source, respectively. Ferrocene (0.4 wt %) and thiophene (0.2 wt %) were dissolved in ethanol through mild sonication. The quartz tube reactor was heated to the growth temperature (1025° C.) using a tube furnace under a constant flow of argon (860 sccm) and hydrogen (300 sccm). After the furnace reached the growth temperature, the ferrocene/ethanol solution was injected continuously into the reactor at a 6 mL/h rate for the duration of the CNT growth. The growth of SWNTs and their quality (G/D>70) were confirmed by SEM, TEM and Raman spectroscopy (inVia, Renishaw) and TGA analysis (TGA/DSC1, Mettler Toledo).

As-grown SWNTs may contain from few to more than 15 wt % Fe catalyst particles depending on synthesis conditions. Optimization of conditions allows for the production of nanotubes with less than 5 wt % Fe catalyst particles that are encapsulated by the multilayer carbon and thereby do not interfere with electrochemical reactions

The self-standing composite sheets produced by this process contained from 0.26 to 23 wt % SWNTs, confirmed by TGA. The active cathode material used was Li—Ni_{0.5}Mn_{0.3}Co_{0.2}O₂ (NMC=5:3:2) (MTI Corporation) and graphite flakes for anode (Alfa Aesar 7-10 micron, 99%). SEM and Raman measurements confirmed that upon mixing with SWNTs, the active materials remained intact. The ratio between SWNTs and battery active material (LNMC or graphite flakes) was controlled by variation of carrier gas (Ar) flow.

The final electrodes were pressed from the deposited film to the desired thicknesses using a roll mill and were then cut to the required size, resulting in self-standing composite sheets of LNMC or Gr embedded in an SWNT network.

### Example I(b): Physical Analysis of Self-Standing Composite Electrode

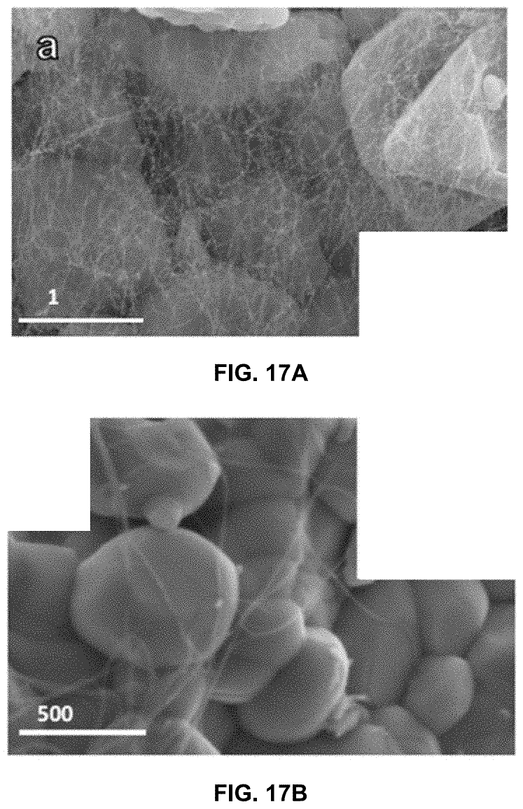

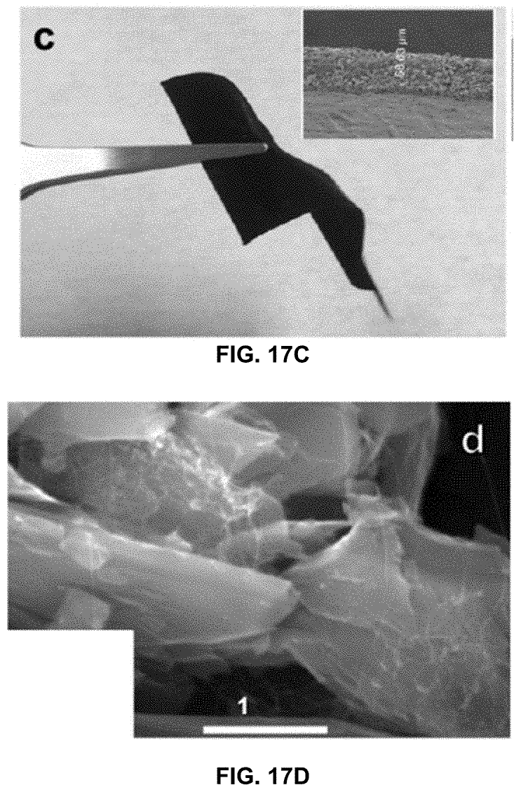

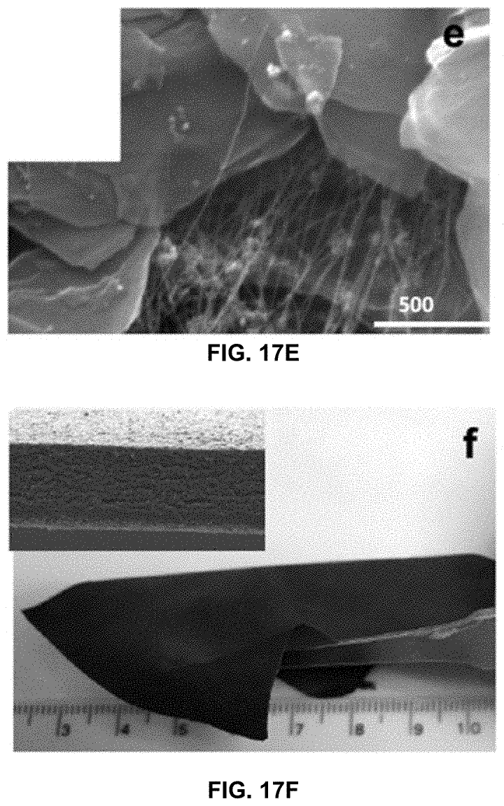

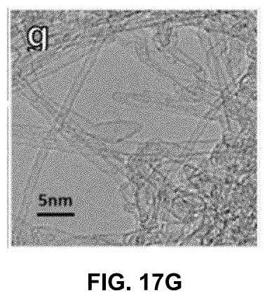

Scanning electron microscopy (SEM) images of as-deposited electrode materials prepared according to Example 1(a) show loosely packed LNMC (Gr) particles embedded in a homogeneous three dimensional cross-linked fine SWCNT network (FIG. 17A). The SWNT network appeared to consist primarily of either individual nanotubes or small bundles of them. Moderate pressing led to denser packing of the active material particles, reduced porosity of the material, and increased mechanical robustness of the sheet.

FIGS. 17A, 17B, and 17C show an example of a flexible cathode sheet (NMC powder in 0.5 wt % SWNTs, 68.6 μm thick), while FIGS. 17D, 17E, and 17F show an example of a flexible anode sheet (graphite flakes in 11 wt % SWNTs, 348 μm thick). The Raman spectroscopy studies confirmed that SWNTs remained intact during self-standing sheet fabrication. Cathode loading reached 170 mg of NMC per cm², translating to an areal capacity density of 25 mAh/cm².

### Example II(a): Measurements of Electrical and Mechanical Properties of Self-Standing Composite Electrode

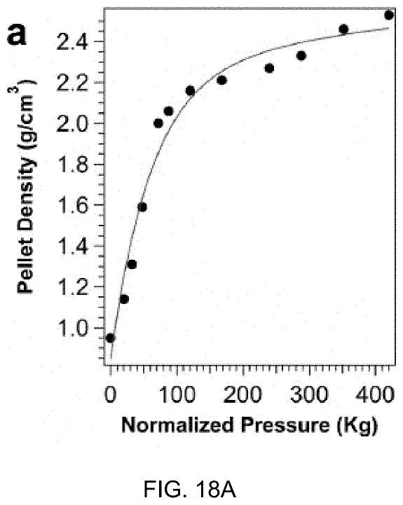

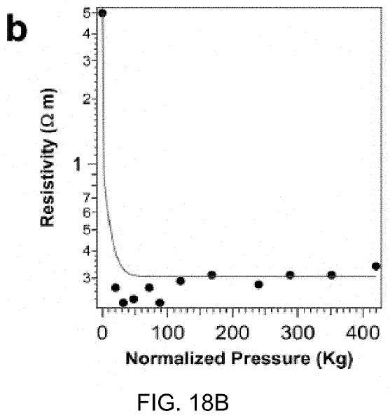

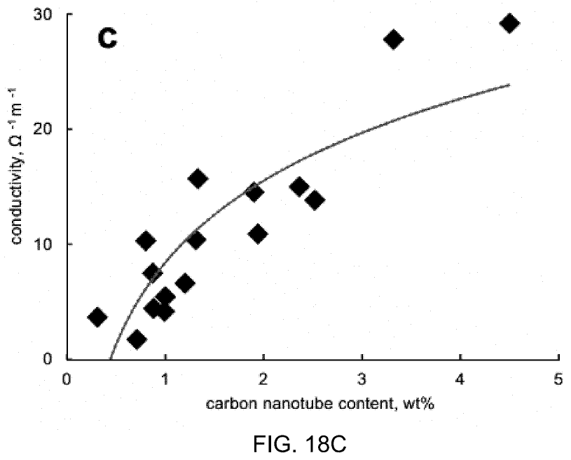

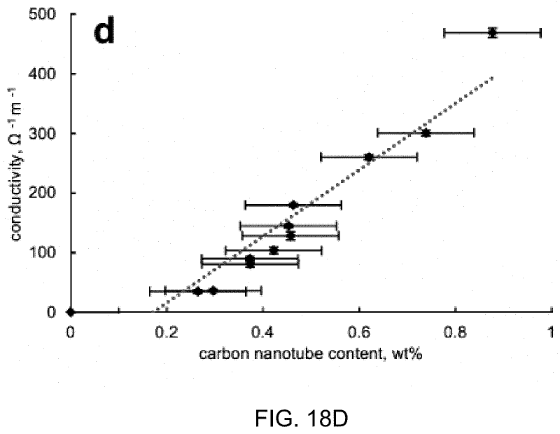

Powder resistivity measurements of the electrodes prepared according to Example I(a) were carried out in situ with a customized die set to compress the powders while measuring their resistivity in a 4-point probe geometry. The probe measured powders under constant pressure with an Applent AT528 micro ohmmeter. The die set consisted of a stainless steel tube of either 10 mm or 5 mm diameter with an insulating ceramic insert tightly fitted within the outer wall. The resistivity was calculated by the equation:

$$ρ = \frac{A * R}{L} = \frac{π * {( \frac{D}{2} )}^{2} * R}{L} = \frac{π {D}^{2} R}{4 L}$$

where A is the area, R is the resistance, L is the thickness, and D is the diameter of the compressed pellet. Pellet density was calculated by:

$${ρ}_{w} = \frac{Weight}{Volume} = \frac{4 W}{π {D}^{2} L}$$

where W is the weight, L is the thickness, and D is the diameter of the pellet. Typical resistivity vs. pressure and pellet density vs. pressure curves followed a log like behavior as shown in FIGS. 18A, 18B, and 18C, where the time interval between sequential pressure data points was 5 minutes.

Electrical resistance of electrode material was measured using a custom setup. The sample was attached by a silver-plated copper clamps, which served as electrical contacts. The same torque was used when affixing samples in the clamps for consistency. The minimal distance between the clamps/contacts was 30 mm. Resistance was measured using a 4-point probe geometry by Applent AT528 micro ohmmeter. One of the clamps was stationary, while the second one was moved by a micrometer screw, thereby stretching the sample. Changes in the sample geometry were tracked and taken into account for sheet resistance and conductivity calculations.

Stress-strain characteristics of electrode materials were measured using Expert 7600 (ADMET) testing machine at 1 mm/sec displacement. The samples were 10 mm wide and placed in the testing machine such that the distance between the clamps was 30 mm.

### Example II(b): Electrical and Mechanical Analysis of Self-Standing Composite Electrode

The electrical conductivity of electrodes is an important parameter, especially for cathodes, because conductivity of NMC (5:3:2) compressed powder was measured to be about 10⁻² Ω⁻¹ m⁻¹. FIGS. 18A-18D show the dependence of electrical conductivity of the NMC and SWNT composite material on the wt % of SWNTs measured using compressed powder pellets. Even at relatively low nanotube concentrations, the conductivity of the composite material became about 100 times higher than conductivity of pristine NMC powder, which was considered to be a percolation threshold. Dependence of electrical conductivity percolation threshold on nanotube properties (e.g., diameter, length, bundle size, and dispersion homogeneity) has been studied intensively, specifically on based of rod models. Although most of the models consider the percolation problem within a 2D frame, it is noticeable that, except for the mentioned parameters, the nature of interaction or connectedness between tubes can markedly amend the percolation threshold. Without wishing to be bound by theory, it is hypothesized that the method as described herein allows exploitation of the intrinsic features of pristine SWNTs without affection by any post-synthesis treatments or presence of residual surfactants.

While using compressed composite powder pellets, the electrical conductivity percolation point was estimated and dispersion homogeneity was confirmed. In battery applications, self-standing composite sheets generally can demonstrate different behavior and even order of magnitude higher conductivity values. Therefore, conductivity dependence on nanotube concentration of the self-standing sheets was also studied (FIG. 18D). It was determined that the self-standing composite sheets demonstrated noticeable higher conductivity (FIG. 18D). The difference was attributed, among other reasons, to the nanotube arrangements in the pressed powder and the sheets.

For battery applications, a low concentration of nanotubes in the electrode sheet is believed to be preferable given that it results in higher gravimetric energy density of the battery. However, self-standing electrodes with a low concentration of nanotubes (ca. 0.25-0.5 wt %) typically possesses a conductivity about 10¹⁻² Ω⁻¹ m⁻¹ and are typically mechanically weak and prone to irreversible deformation, while electrode sheets with a high concentration of nanotubes (>5 wt %) are mechanically robust, very flexible, and have high electric conductivity (≥10³ Ω⁻¹m⁻¹), yet are also very adhesive to various surfaces and thereby hard to process. Based on the above, it was necessary to determine the optimal CNT concentration that satisfies both energy and mechanical requirements.

The thickness of the sheets is another parameter for battery electrodes. In thicker electrodes, the average diffusion distance for Li ions is generally greater than that for thinner ones, often resulting in inferior dynamic performance of the batteries with very thick electrodes and possibly reduced capacity due to underutilization of the inner parts of the electrode. Moreover, during bending of flexible batteries, thicker electrodes generally experience higher differential deformation (stretching on the outer surface and compression on the inner one), which could eventually cause damage during repeated bending. Therefore, a self-standing electrode composition should be optimized considering maximum possible Li-storage value, acceptable electrical conductivity, ease of handling and robust mechanical properties, including tolerance against various mechanical stresses.

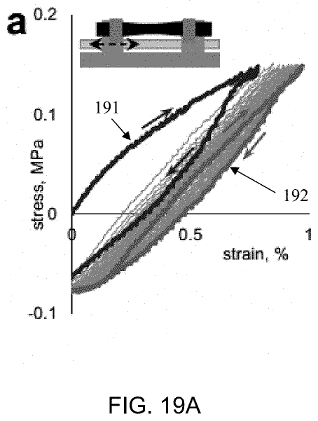

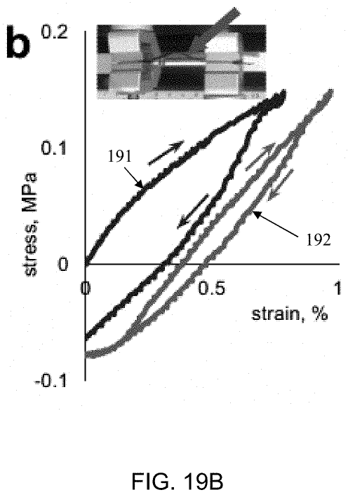

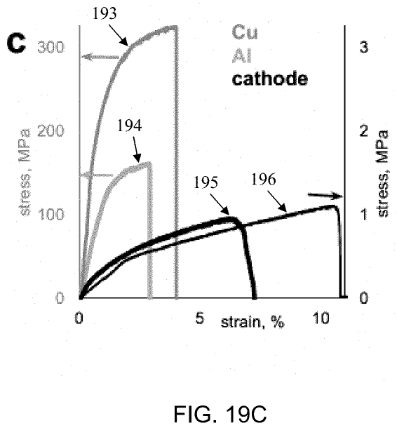

Based on the above, mechanical properties of composite sheets having different concentrations of SWNTs and densities as well as the tolerance of their sheet resistance to various mechanical forces were studied as described herein. FIGS. 19A and 19B show examples of strain vs. stress diagrams of self-standing cathode sheets with different nanotube concentrations, densities, and thicknesses, as described herein. FIG. 19B shows a stress-strain curve for cathode material sheets with 0.9 wt % SWNT, specifically the hysteresis after the first strain cycling 191 and twenty-fifth strain cycling 192, as described in the Examples.

Compared to aluminum and copper foils, which are used as current collectors in commercial batteries, the studied electrode sheets tolerated lower stress but tolerated about twice larger strain, as shown below in Table 1 and also in FIG. 19C. FIG. 19C shows a stress-strain curve 193 for Cu foil and a stress-strain curve 194 for Al foils, a stress-strain curve 195 self-standing sheets with 1.8 wt % SWNT, 0.9 g/cm³, and a stress-strain curve 196 for self-standing sheets with 3.6% wt % SWCNT, 0.74 g/cm³, as described in the Examples For wearable battery electrodes, strain tolerance is important because during bending of the battery, the inside components experience stretching/compression.

TABLE 1
Measured Values of Young Modulus for Self-Standing Composite
and Pure Carbon Nanotube Self-Standing Sheets/Buckypapers

| | | Young's | Tensile | Strain at | |
|---|---|---|---|---|---|
| Self-standing | Density | modulus | strength | fracture | Density |
| sheet | (g/cm³) | (MPa) | (MPA) | (%) | (g/cm³) |
| LiNMC + 0.9 wt % | 1.33 | 28.0 | 0.4 | 5.2 | 1.33 |
| SWNTs | | | | | |
| LiNMC + 3.6 wt % | 0.74 | 72.7 | 1.3 | 6.5 | 0.74 |
| SWNTs | | | | | |
| Graphite + 10.0 | 0.7 | 3.7 | 0.1 | 6.0 | 0.7 |
| wt % SWNTs | | | | | |
| SWNT/Au | | 5.33 | 19.55 | | |
| nanoparticles | | | | | |
| buckypaper | | | | | |
| SWNT | 0.65 | 6.48; 293 | 42 | | 0.65 |
| buckypaper | | | | | |
| MWNT | 0.35 | 1.39; 3.75; | 11.2; 11.6; | 2.2; 8.9 | 0.35 |
| buckypaper | | 282; 1370 | 28.7 | | |

The Young modulus for the SWNT-containing composite sheets shown in Table 1 were estimated using the following formula depending on nanotube concentration and density being in the range of 0.9-3.6 wt %, and of 0.7-1.33 g/cm³:

$$E ≡ \frac{σ ( ɛ )}{ɛ} = \frac{F \text{/} A}{Δ L \text{/} {L}_{0}} = \frac{{FL}_{0}}{A Δ L}$$

where σ—is stress, F—is applied force, A—is cross section area of the sheet, L₀ and ΔL are the initial length and elongation, respectively. In an embodiment of a wearable device, a self-standing electrode has a Young modulus of between about 20 and 75 MPa.

As it can be seen in FIG. 19B, the cathode sheet under cyclical load demonstrated hysteresis behavior similar to elastic-plastic tensile behavior. It was observed that this behavior varies depending on nanotube concentration and loading stress. The samples showed both reversible and irreversible extension components. Lower nanotube content samples showed higher plasticity. Samples with higher nanotube content were stiffer than those with low nanotube content. However, after a few cycles, the hysteresis behavior diminished, as the sample “adjusted” to its new conditions.

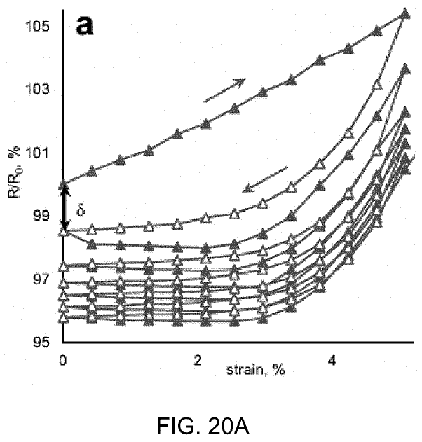

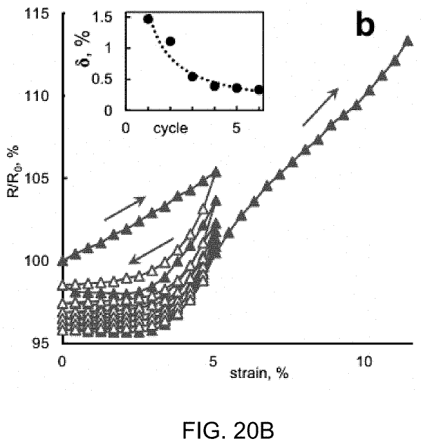

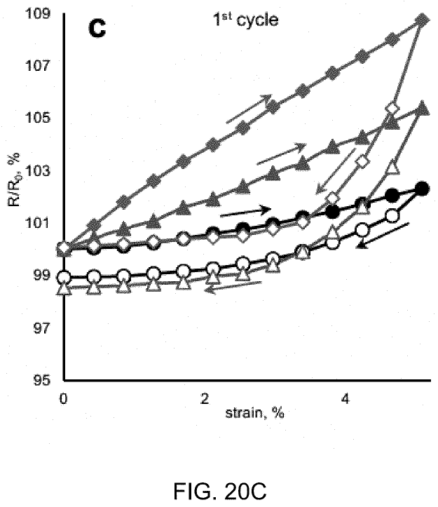

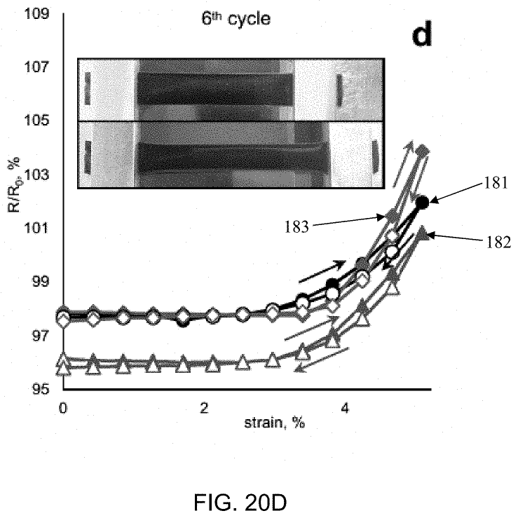

The electrical resistance of sheets with various SWNT concentrations subjected to mechanical stresses was also studied, as shown in FIGS. 20A-20D. In these experiments, the electrode material was stretched at about 2 μm/sec on average, and most samples survived 10-15% elongation before they broke (FIGS. 20A and 20B), significantly more than only 5-6% breaking strain observed in experiments on the stress-strain testing machine, where they were stretched much faster at 1000 μm/sec. Cyclic resistance vs. strain measurements showed distinct hysteretic behavior of the electrode sheets. It is believed that the hysteresis parameters (not reversible resistance and length) depends not only on the nanotube content, but also on the degree of compression of the sample sheet. For example, the sample which was compressed to 2 g/cm³ density showed a much higher rate of the resistance increase during stretching and wider hysteresis than the same sample compressed to 1 g/cm³, and much wider than the “as deposited” sample (ca. 0.4 g/cm³) (FIG. 20C). After several cycles, the hysteresis became almost negligible for all samples (FIG. 20D), presumably as the composite material (and its SWNT network) adjusted to the new dimensions. In FIG. 20D, the circles 181 indicate “as deposited” sample, ca. 0.4 g/cm³ (Rₒ=42.46Ω, for 1 g/cm³ sample Rₒ=33.35 Ω, for 2 g/cm³ sample Rₒ=31.11Ω); the triangles 182 indicate the sample compressed to 1 g/cm³ prior to stretching; the diamonds 183 indicate 2 g/cm³. The photo insert in FIG. 20D shows a cathode sample before and after stretching. Stationary and movable silver-plated copper clamps serving as electrical contacts are also visible.

It is noteworthy that the resistance of all samples which were stretched and released was slightly lower than the initial resistance, presumably to some ordering (and possibly cross-linking) of the nanotube network along the stretching axis. Multiple stretching cycles seemed to reinforce this effect. This is in contrast to previous studies that reported on resistance-strain behavior of carbon nanotube thin films deposited on polymeric substrate. In some previous studies, the electrical resistance of CNT thin films also exhibited a hysteretic dependence on strain under cycling loading, but the hysteresis shape was very different, and the resistance of the CNT film only increased, and never decreased, even after relaxing of the sample. It is believed that this difference in behavior may be due to the fact that the sheets as described herein are self-standing (i.e., the CNT network is the only thing keeping them together, requiring no substrate) and include three dimensional well-dispersed networks of pristine nanotubes. These networks, when compressed or stretched, can re-orient, cross-link, and bundle, thus increasing the number of electrical contacts and consequently increasing electrical conductivity. In general, conductivity of the self-standing electrode sheets increases with increase of the sheet density, until it approaches the bulk density of the active material, after which it typically starts to decline, presumably because during pressing active material particles collide and start to disrupt CNT network.

Bulk density of NMC powder was measured to be 2.79±0.1 g/cm³, while its crystal density measured using Archimedes' principle was 4.56±0.1 g/cm³. Near the bulk density the sheets started to become brittle, therefore this represents the practical upper limit for the NMC-CNT cathode density. Graphite-CNT anodes typically become fragile past ca. 1.1 g/cm³.

### Example III(a): Battery Assembly and Performance Evaluation

For pouch cell battery assemblies, sheets with optimized characteristics as described in Examples I and II were cut to the required size and tabs were attached to the self-standing collector-free sheets. Freestanding cathodes were matched to freestanding anodes based on the amounts of the active materials and their theoretical capacities. Upon attaching the tabs, pouch cells were assembled using the prepared electrodes, Celgard 2325 separator of 25 μm thickness, and LP71 electrolyte (1M LiPF₆ in EC/DEC/DMC, 1:1:1 mixture by volume, BASF).

The rate test cycling was performed using Parstat MC (Princeton Applied Research) potentiostat between the cut-off voltages of 3.0 V and 4.3 V. Charging was done at 0.2 C; discharge was done at 0.2, 0.4, 1, 2, 5, 7, 10, 20, 30, 50 C.

Performance of flexible cells subjected to mechanical stress was tested using the following procedure: after 10 cycles of 0.2 C charge and 0.2 C discharge, the cell was bent over a one-inch diameter rod, then bent in the opposite direction over the same rod. This was repeated 10 times. Then another 10 cycles of 0.2 C charge/discharge were performed. Then another 10 bends back and forth were done, and then the procedure was repeated.

### Example III(b): Battery Assembly and Performance Evaluation

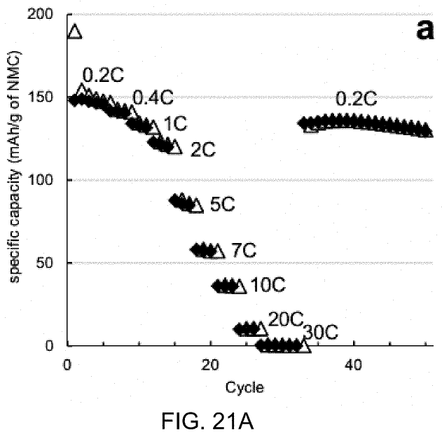

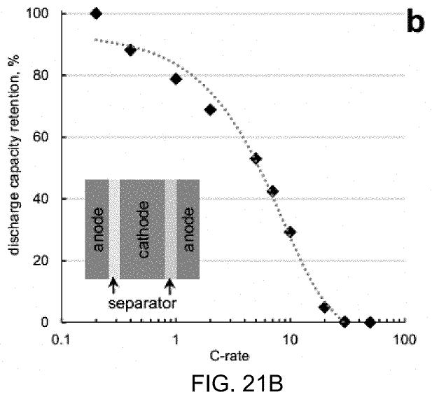

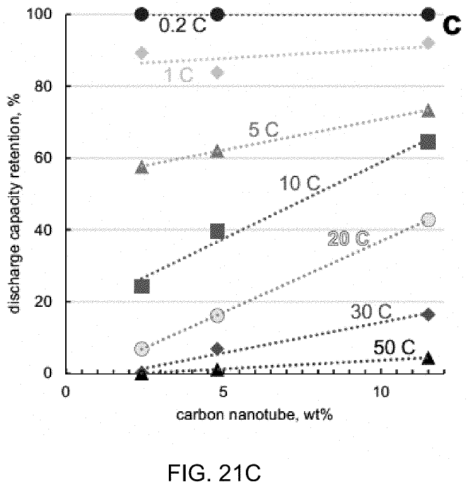

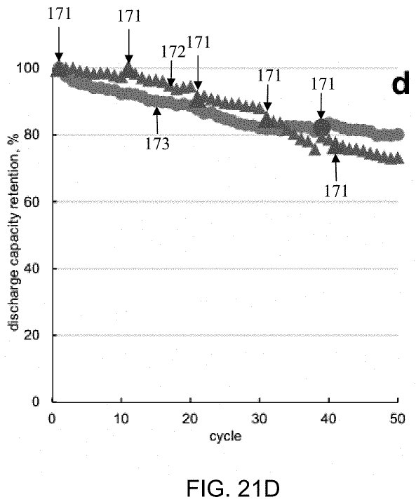

Two cell configurations were tested: single self-standing collector-free cathode (FIG. 21A) and single self-standing collector-free cathode with two anodes on both sides (FIG. 21B). In FIGS. 21A and 21B, open triangles indicate charging performance, and diamonds indicate discharge performance. It was observed that the self-standing collector-free cathodes with a nanotube concentration of ≥1 wt % and thickness of 0.1-0.3 mm demonstrated high C-rate tolerance and retained about half of their capacity (compared to that at 0.2C) at 5 C-rate, and retained some capacity even at 20C (FIG. 21C). Based on these results, cells with both self-standing and collector-free cathode and anode were selected and assembled.

FIG. 21D shows the electromechanical performance of the cell (5.3 wt % SWNT in 0.18 mm thick cathode, 16.6 wt % SWCNT in 0.2 mm thick anode) that was tested while subjected to mechanical stress as described in Example III(a). In FIG. 21D, symbols 171 indicate the cycles when the cell was subjected to mechanical stresses. The cell marked with triangles 172 was subjected to mechanical stress every 10 cycles, while the cell marked in circles 173 remained undisturbed most of the experiment. The insert shows impedance of the cell before and after cycling. Performance of the flexible battery subjected to regular mechanical stress was almost identical to that of a similar battery which remained undisturbed during most of the experiments (FIG. 21D). It is believed that the observed performance detrimental effect on the cycling stability primarily was attributed to inefficient encapsulation by commercial packaging film for conventional cells, which provided insufficient compacting of electrodes to the separator membrane.

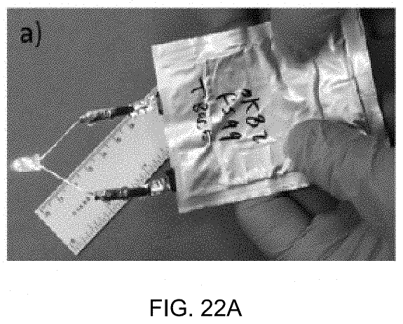

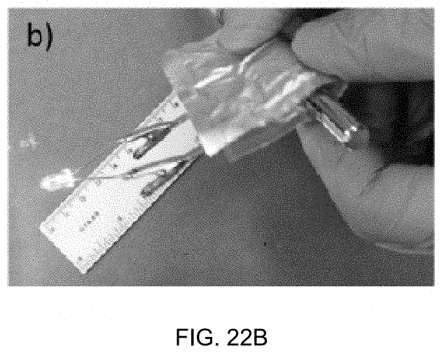

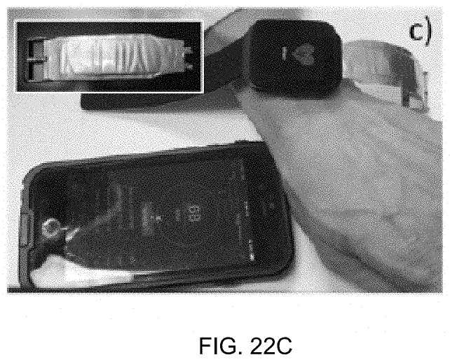

To demonstrate feasibility of the battery architecture as described herein, a flexible battery shaped as a wristband was fabricated and used to power a commercial smartwatch. The watch featured a heart rate monitoring sensor, was capable of transferring data to a cellphone via Bluetooth (FIG. 22C), and came with a power source of 3.7 V and 250 mAh. As shown at FIGS. 22C and 22C, a battery as described herein successfully charged via the watch's USB charger, start and ran the watch, operated the sensor, and transferred data to an iPhone.

### Example IV: Conclusions

Based on Examples I-111, it was concluded that the novel mixing process of as-grown floating SWNTs and aerosolized battery active material powders as described herein produced self-standing, binder free, flexible electrode composite sheets. The method provided an exceptionally homogeneous dispersion of pristine carbon nanotubes throughout the composite material. As a result, even at the low loading of nanotubes (˜0.3 wt %), electrical conductivity of the material was 10¹⁻² Ω⁻¹m⁻¹, increasing to 10³⁻⁴ Ω⁻¹m⁻¹ past 5 wt % CNT.

The material showed a high tolerance against various mechanical stresses. The strain vs. stress results suggested a Young modulus in the range of 20-75 MPa depending on the nanotube concentration, and breaking strain of up to 10-15% breaking strain at 2 μm/sec extension rate.

The electrical resistance vs. strain graphs demonstrated hysteresis behavior for initial cycles, however, after 5-6 cycles, the hysteresis became negligible, demonstrating high conformity of the material.

It was concluded that the suitable parameters for the NMC-CNT freestanding cathodes may include 0.5-5 wt % SWNT, 1-2.3 g/cm³ density, and 0.05-0.5 mm thickness. Gr-SWNT freestanding anodes may include 2-20 wt % SWNT, 0.5-1.1 g/cm³ density, and 0.05-0.5 mm thickness. The application of such self-standing sheets as electrodes may create batteries without metal current collector foils and binders, thus eliminating electrochemically inactive components from battery structure. Therefore, such batteries are capable of approaching the limits of specific energy density values imposed by the Li-storage active material, e.g., NMC powder.

The wristband shaped flexible battery fabricated by this technology was demonstrated to successfully power a commercial smart watch with heart rate sensor and wireless data transfer capabilities. The fabrication of self-standing electrodes and proposed current collector and binder free battery architecture as described herein may therefore be used to provide secondary flexible batteries with a high energy density for wearable electronics.

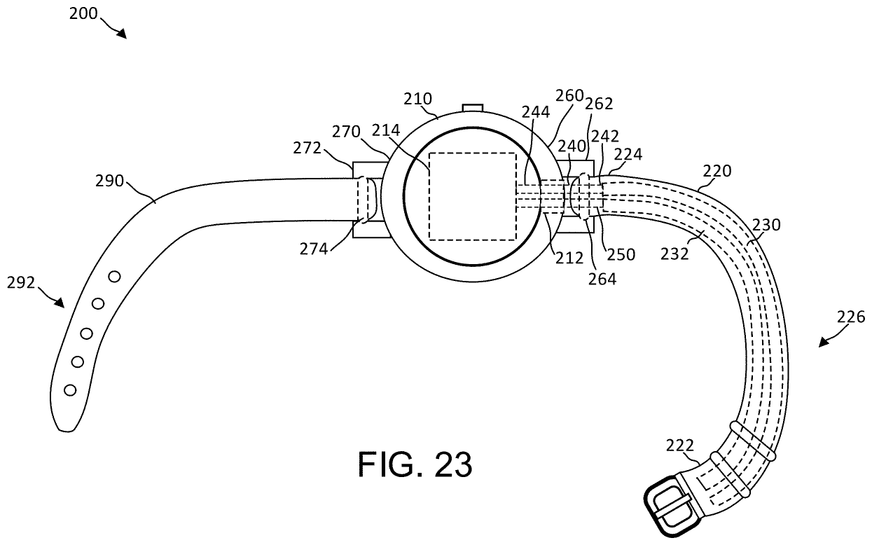

FIG. 23 shows an example wearable device 200 that includes a flexible battery as described herein. The wearable device 200 includes a housing 210. The housing 210 may define an internal space that includes an electronic component 214 positioned within the housing 210. For example, the housing 210 may be a watch case that includes a digital watch electronic component such as a printed circuit board and display. An internal wall of the housing 210 defines an opening 212 that extends from the internal space to an exterior of the housing 210. The wearable device 200 includes a first strap 220 having a first end 222 and a second end 224. A length 226 extends from the first end 222 to the second end 224. The strap may be, for example, formed of leather, plastic, or silicone. The wearable device 200 includes a first self-standing electrode 230. As described herein, the first self-standing electrode 230 includes a battery active material in a carbon nanotube network (e.g., a SWNT network). The first self-standing electrode 230 may extend continuously along the length 226 from the first end 222 to the second end 224. The wearable device 200 includes a first tab 240 including a first end 242 and a second end 244. The first end 242 is positioned in the first strap 220 in contact with the first self-standing electrode 230. The second end 244 extends outward of the second end 224 of the first strap 220 through the opening 212 and is positioned in the housing 210 in electrical communication with the electronic component 214. For example, the opening 212 may be a port that receives the first tab 240 and electrically couples the first tab 240 with the electronic component 214 when the first tab 240 is received.

In an embodiment, wearable device 250 may include a second self-standing electrode 232 that extends from the first end 222 to the second end 224. The wearable device 250 may include a second tab 250 positioned in electrical communication with the electronic component 214 and the second self-standing electrode 232.

In an embodiment, the housing 210 includes a first side 260 and a second side 270. The opening 212 is positioned on the first side 260 of the housing 210. The first end 222 of the strap 220 may be secured to the second side 270 of the housing 270. For example, the first end 222 may be permanently attached to the second side 270 and a portion of strap 220 may stretch to allow wearing and removal. As another example, the first end 222 may be secured to the second end 270 via a fastener such as a clip or buckle. The second end 224 of the strap 220 may include a lug 264 extending through the second end 224 perpendicular to the length 226 of the first strap 220. The first tab 240 and the second tab 250 may be routed around the lug 264 and insulated by the first strap 220 or a separate insulation material. The lug 264 may be secured to the first end 260 of the housing 210, for example, via a retaining arms 262.

In another embodiment, the wearable device 200 may include a buckle 280 and a buckle tongue 282. The buckle 280 and the buckle tongue 282 may be secured to the first end 222 of the first strap 220. The buckle 280 may be secured to a second strap 290, for example, via adjustment holes 292. The second strap 290 may be secured to the second end 270 via retaining arms 272 and lug 274.

What is claimed is:

1. A flexible lithium ion battery, the flexible lithium ion battery comprising:
two or more flexible self-standing electrodes, each flexible self-standing electrode comprising one or more conductive battery tabs attached to and extending from each flexible self-standing electrode;
flexible material packaging operative to contain the two or more flexible self-standing electrodes, wherein the conductive battery tabs extend from the flexible self-standing electrodes through the flexible material packaging and external to the flexible material packaging,
wherein the flexible lithium ion battery has a shape of a wearable band.

2. The flexible lithium ion battery of claim 1, wherein the conductive battery tabs are flexible.

3. The flexible lithium ion battery of claim 1, wherein the flexible lithium ion battery is free of current collector, free of binder, or free of both current collector and binder.

4. The flexible lithium ion battery of claim 1, further comprising a solid electrolyte between each of the two or more flexible self-standing electrodes.

5. The flexible lithium ion battery of claim 1, wherein the flexible material packaging is selected from a polymer, a fabric, an elastic, a foil, and combinations thereof.

6. The flexible lithium ion battery of claim 1, further comprising extending flexible battery tabs attached to the one or more conductive battery tabs attached to and extending from each flexible self-standing electrode.

7. An electronic device comprising:
the flexible lithium ion battery according to claim 1; and
one or more of a processor, a sensor, a receiver, a transmitter, an audio device, a light emitting device, and a display electrically connected to the flexible lithium ion battery.

8. The flexible lithium ion battery of claim 1, wherein each flexible self-standing electrode comprises:
a plurality of carbon nanotubes arranged in a webbed morphology with interconnected spaces among the carbon nanotubes, the interconnected spaces comprising:
an electrode active material; and
an electrolyte.

9. The flexible lithium ion battery of claim 8, wherein the electrolyte is selected from NASICON, garnet, perovskite, LISICON, LiPON, Li₃N, sulfide, argyrodite, and anti-perovskite.

10. The flexible lithium ion battery of claim 4, wherein the electrolyte has a thickness from about 10 microns to about 20 microns.

11. The flexible lithium ion battery of claim 5, wherein the flexible material packaging comprises one or more layers selected from flexible polymer, foil, rubber, fabric, biocompatible material, organic material, material with components and processors embedded in and imprinted upon the flexible material packaging, and combinations thereof.

12. The flexible lithium ion battery of claim 1, wherein the wearable band is selected from the group consisting of a wristband, a head band, an ankle band, a chest band, an armband, a sleeve, and an article of clothing.

13. The flexible lithium ion battery of claim 6, wherein the extending flexible battery tabs comprise spring metal, conductive polymer, carbon nanotubes, or a combination thereof.

14. The flexible lithium ion battery of claim 1, wherein the flexible lithium ion battery is free of a separator, free of a current collector, and free of a binder.

15. A method of making an electronic device, the method comprising:
(a) providing two or more flexible self-standing electrodes with conductive battery tabs extending from the flexible self-standing electrodes; and
(b) containing two or more flexible self-standing electrodes inside a flexible battery pouch cell, with the conductive battery tabs extending external to the flexible battery pouch cell, to form a flexible lithium ion battery having a shape of a wearable band.

16. The method of claim 15, wherein the method further comprises:
(c) electrically connecting the flexible lithium ion battery with at least one of a processor, a sensor, a receiver, a transmitter, an audio device, a display, and a light emitting device to provide an electronic device.

17. The method of claim 16, wherein the at least one processor, sensor, receiver, transmitter, audio device, display, and light emitting device is provided upon the flexible battery pouch cell.

18. The method of claim 15, further comprising adding a solid electrolyte between each of the two or more flexible self-standing electrodes.

19. The method of claim 15, further comprising attaching extending battery tabs to the conductive battery tabs extending from the flexible self-standing electrodes, the extending battery tabs comprising a flexible material.

20. A wearable device, comprising:
a housing including an opening;
an electronic component positioned in the housing;
at least a first strap including a first end, a second end, and a length extending from the first end to the second end;
a first self-standing electrode comprising a battery active material in a carbon nanotube network, the first self-standing electrode is housed in the first strap and extends continuously along the length of the first strap between the first end and the second end of the first strap; and
at least a first tab including a first end and a second end, wherein the first end of the first tab is positioned in the first strap in contact with the self-standing electrode, and wherein the second end of the first tab extends outward of the second end of the first strap through the opening of the housing and is positioned in the housing in electrical communication with the electronic component.

21. The wearable device of claim 20, wherein the housing comprises a first side and a second side, wherein the opening is positioned on the first side of the housing, and the first end of the first strap is secured to the second side of the housing.

22. The wearable device of claim 20, further comprising a buckle and a buckle tongue, wherein buckle and the buckle tongue are secured to the first end of the first strap.

23. The wearable device of claim 22, further comprising a second strap secured to the housing, the second strap including a plurality of adjustment holes configured to receive the buckle tongue.

24. The wearable device of claim 20, further comprising a lug extending through the second end of the first strap perpendicular to the length of the first strap, wherein the lug is secured to the housing.

25. The wearable device of claim 20, wherein the first tab is flexible.

26. The wearable device of claim 20, wherein the self-standing electrode is free of current collector, free of binder, or free of both current collector and binder.

27. The wearable device of claim 20, further comprising a second self-standing electrode and a solid electrolyte between the first self-standing electrode and the second self-standing electrode.

28. The wearable device of claim 20, wherein the first self-standing electrode has a Young modulus of between about 20 and 75 MPa.

29. A strap for a wearable device comprising:
a flexible body including a first end, a second end, and a length extending from the first end to the second end;
a self-standing electrode comprising a battery active material in a carbon nanotube network, the self-standing electrode is housed in the body and extends continuously along the length of the body between the first end and the second end of the body;
at least a first tab including a first end and a second end, wherein the first end of the first tab is positioned in the body in contact with the self-standing electrode, and wherein the second end of the first tab extends outward of the second end of the body and is insertable through the opening of a housing for an electronic component; and
a buckle and a buckle tongue, wherein buckle and the buckle tongue are secured to the first end of the body.
